(19) United States
(12) Patent Application Publication
(10) Pub. No.: US 2026/0222914 A1
(43) Pub. Date: Jul. 30, 2026

(54) WIRELESS COMMUNICATION DEVICE AND WIRELESS COMMUNICATION METHOD

(71) Applicant: SONY GROUP CORPORATION, TOKYO (JP)

(72) Inventors: SHIGERU SUGAYA, TOKYO (JP); RYUICHI HIRATA, TOKYO (JP)

(21) Appl. No.: 19/139,391

(22) PCT Filed: Dec. 12, 2023
(86) PCT No.: PCT/JP2023/044358

§ 371 Date: Jun. 16, 2025

(30) Foreign Application Priority Data
Dec. 26, 2022 (JP) 2022-208853

(51) Int. Cl. H04W 28/06; H04L 1/1607; H04L 5/00

(52) U.S. Cl. CPC H04W 28/065; H04L 1/1642; H04L 5/0053

(57) ABSTRACT

The present disclosure relates to a wireless communication device and a wireless communication method capable of improving utilization efficiency of a transmission path. There is provided a wireless communication device including a control unit that performs control of generating first data and second data by dividing transmission data, transmitting a data frame including the first data or the second data, and receiving an acknowledgement response frame including receipt information indicating a receipt status of the first data or the second data, the acknowledgement response frame being transmitted from another wireless communication device that has received the data frame. The present disclosure may be applied to, for example, a wireless communication device included in a wireless LAN system.

### TECHNICAL FIELD

The present disclosure relates to a wireless communication device and a wireless communication method, and more particularly, to a wireless communication device and a wireless communication method capable of improving utilization efficiency of a transmission path.

### BACKGROUND ART

In an existing wireless local area network (LAN) system, a technique of transmitting and receiving data having a large amount of information in a smaller transmission unit by performing fragment processing of fragmenting a MAC layer service data unit (MSDU) with a certain information length has been used.

As a technique related to the fragment processing, for example, a technique disclosed in Patent Document 1 is known. Patent Document 1 discloses a technique of determining a fragmentation level by transmitting an Add Block Ack (ADDBA) request frame from a transmitter to a receiver to return an ADDBA response frame from the receiver to the transmitter.

Furthermore, according to an existing block ACK frame that has been used as a receipt acknowledgment, receipt is acknowledged on the basis of a sequence number assigned in an MSDU unit. Alternatively, a MAC layer protocol data unit (MPDU) is configured in units of data obtained by fragmenting one MSDU into a plurality of pieces, whereby ACK information is exchanged in a pseudo manner.

### CITATION LIST

### Patent Document

Patent Document 1: Japanese Patent Application Laid-Open No. 2020-195163

### SUMMARY OF THE INVENTION

### Problems to be Solved by the Invention

However, according to the configuration in which the receipt is acknowledged on the basis of the sequence number assigned in the MSDU unit, it has been difficult to exchange receipt information in a fragmented unit. When the receipt information may not be exchanged in the fragmented unit, a retransmission unit at a time of retransmitting data becomes larger than the fragmented unit, whereby the utilization efficiency of the transmission path may be deteriorated. In view of the above, it is required to improve the utilization efficiency of the transmission path.

The present disclosure has been conceived in view of such a situation, and enables improvement in the utilization efficiency of the transmission path.

### Solutions to Problems

A wireless communication device according to one aspect of the present disclosure is a wireless communication device including a control unit that performs control of generating first data and second data by dividing transmission data, transmitting a data frame including the first data or the second data, and receiving an acknowledgement response frame including receipt information indicating a receipt status of the first data or the second data, the acknowledgement response frame being transmitted from another wireless communication device that has received the data frame.

A wireless communication method according to one aspect of the present disclosure is a wireless communication method that causes a wireless communication device to generate first data and second data by dividing transmission data, transmit a data frame including the first data or the second data, and receive an acknowledgement response frame including receipt information indicating a receipt status of the first data or the second data, the acknowledgement response frame being transmitted from another wireless communication device that has received the data frame.

According to a wireless communication device and a wireless communication method according to one aspect of the present disclosure, first data and second data are generated by dividing transmission data, a data frame including the first data or the second data is transmitted, and an acknowledgement response frame including receipt information indicating a receipt status of the first data or the second data, the acknowledgement response frame being transmitted from another wireless communication device that has received the data frame, is received.

A wireless communication device according to one aspect of the present disclosure is a wireless communication device including a control unit that performs control of receiving a data frame, which is transmitted from another wireless communication device and includes first data or second data generated by dividing transmission data, restoring the transmission data from the first data and the second data obtained from the data frame to construct the restored transmission data as reception data, and constructing an acknowledgement response frame including receipt information indicating a receipt status of the first data or the second data and transmitting the acknowledgement response frame to the another wireless communication device.

A wireless communication method according to one aspect of the present disclosure is a wireless communication method that causes a wireless communication device to receive a data frame, which is transmitted from another wireless communication device and includes first data or second data generated by dividing transmission data, restore the transmission data from the first data and the second data obtained from the data frame to construct the restored transmission data as reception data, and construct an acknowledgement response frame including receipt information indicating a receipt status of the first data or the second data and transmit the acknowledgement response frame to the another wireless communication device.

According to a wireless communication device and a wireless communication method according to one aspect of the present disclosure, a data frame, which is transmitted from another wireless communication device and includes first data or second data generated by dividing transmission data, is received, the transmission data is restored from the first data and the second data obtained from the data frame and is constructed as reception data, and an acknowledgement response frame including receipt information indicating a receipt status of the first data or the second data is constructed and is transmitted to the another wireless communication device.

Note that the wireless communication device according to one aspect of the present disclosure may be an independent device, or may be an internal block constituting one device.

### BRIEF DESCRIPTION OF DRAWINGS

FIG. 1 is a diagram illustrating an exemplary configuration of a wireless LAN system to which the present disclosure is applied.

FIG. 2 is a diagram illustrating an exemplary configuration of a frequency band in which a wireless communication device to which the present disclosure is applied is operable in a multi-link operation.

FIG. 3 is a block diagram illustrating an exemplary configuration of the wireless communication device to which the present disclosure is applied.

FIG. 4 is a block diagram illustrating an exemplary configuration of a wireless communication module in FIG. 3.

FIG. 5 is a diagram illustrating an example of transmission data.

FIG. 6 is a diagram illustrating an exemplary fragment according to a transmission opportunity.

FIG. 7 is a diagram illustrating a first example in which fragmented data is configured as one frame.

FIG. 8 is a diagram illustrating an exemplary configuration of a frame to be transmitted at a first transmission opportunity.

FIG. 9 is a diagram illustrating a second example in which fragmented data is configured as one frame.

FIG. 10 is a diagram illustrating an exemplary configuration of a frame to be transmitted at a next transmission opportunity.

FIG. 11 is a diagram illustrating a third example in which fragmented data is configured as one frame.

FIG. 12 is a diagram illustrating an exemplary configuration of a frame to be transmitted at a further next transmission opportunity.

FIG. 13 is a diagram illustrating an exemplary configuration of a communication sequence between the wireless communication devices to which the present disclosure is applied.

FIG. 14 is a diagram illustrating an exemplary configuration of a frame of a fragment block ACK parameter.

FIG. 15 is a diagram illustrating a first exemplary configuration of a fragment block ACK information element.

FIG. 16 is a diagram illustrating a second exemplary configuration of the fragment block ACK information element.

FIG. 17 is a diagram illustrating an exemplary configuration of a block ACK request frame of fragmented data.

FIG. 18 is a diagram illustrating a first example of description of BAR information.

FIG. 19 is a diagram illustrating a second example of description of BAR information.

FIG. 20 is a diagram illustrating a third example of description of BAR information.

FIG. 21 is a diagram illustrating an exemplary configuration of a block ACK frame of fragmented data.

FIG. 22 is a diagram illustrating a first example of description of BA information.

FIG. 23 is a diagram illustrating a second example of description of BA information.

FIG. 24 is a diagram illustrating a third example of description of BA information.

FIG. 25 is a diagram illustrating an exemplary configuration of a delimiter including a block ACK request in a fragment unit.

FIG. 26 is a diagram illustrating a structure of signal processing in a device in an existing wireless LAN system.

FIG. 27 is a diagram illustrating a structure of signal processing in a device in the wireless LAN system according to the present disclosure.

FIG. 28 is a flowchart for explaining a flow of a transmission-side process.

FIG. 29 is a flowchart for explaining a flow of the transmission-side process.

FIG. 30 is a flowchart for explaining a flow of a transmission-side retransmission process.

FIG. 31 is a flowchart for explaining a flow of the transmission-side retransmission process.

FIG. 32 is a flowchart for explaining a flow of a reception-side process.

FIG. 33 is a flowchart for explaining a flow of the reception-side process.

FIG. 34 is a block diagram illustrating an exemplary configuration of a computer.

FIG. 35 is a block diagram illustrating an exemplary schematic configuration of a smartphone to which the present technology is applied.

FIG. 36 is a block diagram illustrating an exemplary schematic configuration of a vehicle-mounted device to which the present technology is applied.

FIG. 37 is a block diagram illustrating an exemplary schematic configuration of a wireless AP to which the present technology is applied.

### MODE FOR CARRYING OUT THE INVENTION

### System Configuration

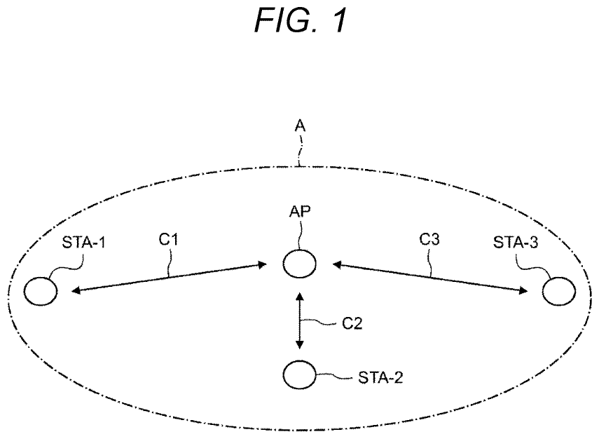

FIG. 1 is a diagram illustrating an exemplary configuration of a wireless LAN system to which the present disclosure is applied.

FIG. 1 schematically illustrates the wireless LAN system, which includes an access point AP and communication terminals STA-1 to STA-3 connected to the access point AP, and is configured as one basic service set (BSS).

A radio wave coverage of the access point AP is indicated by an ellipse A of a dot-and-dash line, and a configuration of forming a network with the communication terminal STA present in the radio wave coverage is illustrated. That is, in this basic service set, each of the communication terminals STA-1 to STA-3 connected to the access point AP wirelessly communicates with the access point AP as indicated by arrows C1 to C3. The access point AP and the communication terminal STA are an example of a wireless communication device to which the present disclosure is applied.

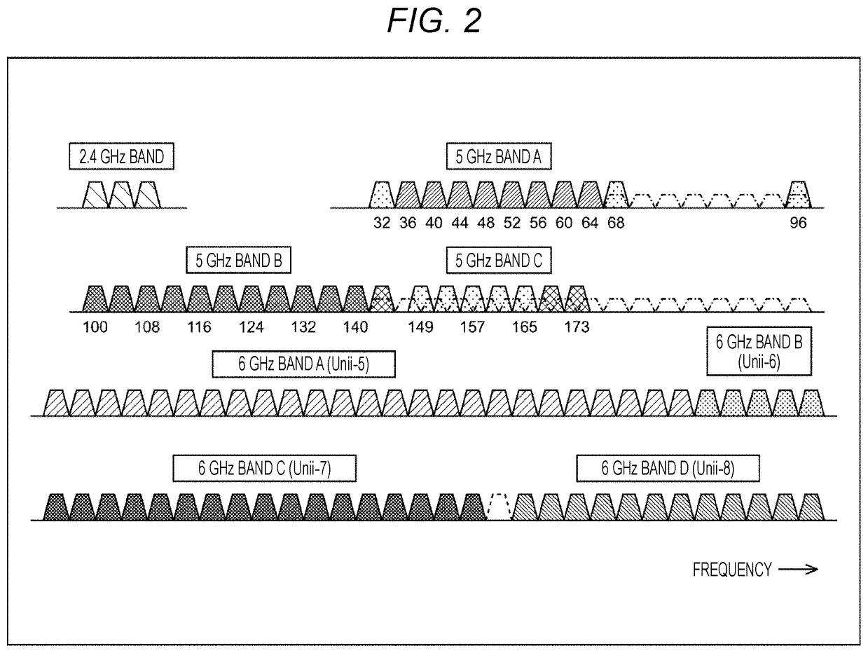

FIG. 2 is a diagram illustrating an exemplary configuration of a frequency band in which the wireless communication device to which the present disclosure is applied is operable in a multi-link operation (MLO).

In FIG. 2, for example, a 2.4 GHz band, a 5 GHz band, and a 6 GHz band are prepared to make the wireless communication device operable in the multi-link operation using each of a plurality of frequency bands. Specifically, the bandwidth of 20 MHz of orthogonal frequency division multiplexing (OFDM) is represented by a trapezoid as one channel, and at least three channels of 20 MHz are arranged in the 2.4 GHz band.

In addition, the 5 GHz band includes a 5 GHz band A, a 5 GHz band B, and a 5 GHz band C. While ten channels of 20 MHz are arranged in the 5 GHz band A, patterns of the trapezoids indicate that the number of channels may be eight depending on legal regulations of the country. While 13 channels of 20 MHz are arranged in the 5 GHz band B, patterns of the trapezoids indicate that the number of channels may be 11 depending on legal regulations of the country. Likewise, it is indicated that seven channels of 20 MHz are arranged in the 5 GHz band C.

Additionally, the 6 GHz band to be used in recent years includes a 6 GHz band A (UNII-5 band), a 6 GHz band B (UNII-6 band), a 6 GHz band C (UNII-7 band), and a 6 GHz band D (UNII-8 band). 24 channels of 20 MHz are prepared in the 6 GHz band A (UNII-5 band), 5 channels of 20 MHz are prepared in the 6 GHz band B (UNII-6 band), 17 channels of 20 MHz are prepared in the 6 GHz band C (UNII-7 band), and 11 channels of 20 MHz are prepared in the 6 GHz band D (UNII-8 band).

Note that, while the wireless communication device to which the present disclosure is applied is capable of performing the multi-link operation using a plurality of frequency bands (links), the multi-link operation is not necessarily performed. Furthermore, in a case where the bandwidth is wide, the multi-link operation may be performed in a plurality of bands depending on a difference in frequency even within the band.

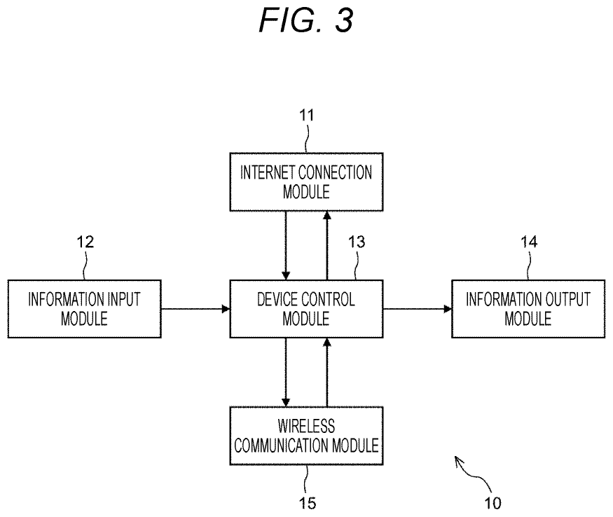

FIG. 3 is a block diagram illustrating an exemplary configuration of the wireless communication device to which the present disclosure is applied. A wireless communication device 10 illustrated in FIG. 3 is configured as the access point AP or the communication terminal STA in the wireless LAN system in FIG. 1. Hereinafter, of the wireless communication device 10, a side that transmits a data frame will also be referred to as a transmission-side communication device 10Tx, and a side that receives the data frame will also be referred to as a reception-side communication device 10Rx.

In FIG. 3, the wireless communication device 10 includes an Internet connection module 11, an information input module 12, a device control module 13, an information output module 14, and a wireless communication module 15.

The Internet connection module 11 performs various types of processing related to the Internet connection under the control of the device control module 13. For example, in a case of operating as an access point AP, the Internet connection module 11 has a function of a communication modem or the like for connecting to the Internet, and carries out Internet connection via a public communication line and an Internet service provider.

The information input module 12 has a function of inputting, to the device control module 13, instruction information corresponding to an instruction from a user. The information input module 12 includes, for example, an input device such as a push button, a keyboard, or a touch panel.

The device control module 13 controls each unit (module) to cause the wireless communication device 10 to operate as an access point AP or a communication terminal STA. The device control module 13 includes, for example, a microprocessor, a microcontroller, a semiconductor memory, and the like.

The information output module 14 has a function of displaying information required for the user on the basis of the information supplied from the device control module 13. Here, the information displayed and informed by the information output module 14 includes, for example, an operation status of the wireless communication device 10, information obtained via the Internet, and the like. The information output module 14 includes, for example, a display element such as a liquid crystal display, or an organic electroluminescence (EL) display, a light emitting diode (LED) display, or an output device including a speaker or the like that outputs sound or music.

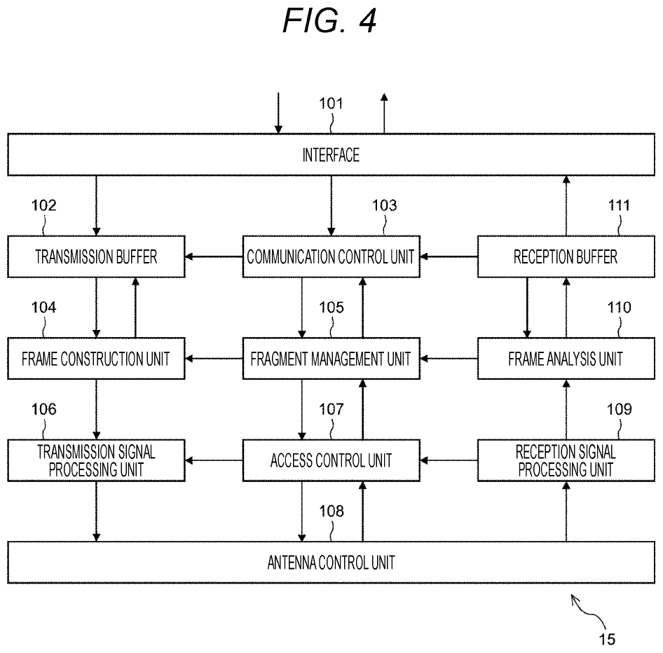

The wireless communication module 15 performs various types of processing related to wireless communication under the control of the device control module 13. The wireless communication module 15 includes, for example, a wireless communication chip, a peripheral circuit, a microcontroller, a semiconductor memory, and the like. Details of the configuration of the wireless communication module 15 will be described later with reference to FIG. 4.

Note that, while the device control module 13 and the wireless communication module 15 are essential components in the wireless communication device 10, whether or not to include the other modules, which are the Internet connection module 11, the information input module 12, and the information output module 14, as components is optional. That is, each wireless communication device 10 that operates as an access point AP or a communication terminal STA may include only required modules, and unrequired portions may be simplified or may not be incorporated. For example, in the wireless communication module 15 in FIG. 3, the Internet connection module 11 may be incorporated only in the access point AP, and the information input module 12 and the information output module 14 may be incorporated only in the communication terminal STA. In the wireless communication module 15, whether or not to include an antenna is optional.

FIG. 4 is a block diagram illustrating an exemplary configuration of the wireless communication module 15 in FIG. 3.

The wireless communication module 15 includes an interface 101 that is connected to another module and exchanges various types of information and data, a transmission buffer 102 that stores data to be transmitted, a communication control unit 103 that manages a series of control according to the present disclosure, and a frame construction unit 104 that constructs a frame to be used for parameter setting, detection notification, and the like.

The wireless communication module 15 is provided with a fragment management unit 105 for managing a dynamic fragment operation of the present disclosure, and performs fragment processing and retransmission processing in a case of operating as the transmission-side communication device 10Tx and receipt acknowledgment processing in a fragment unit in a case of operating as the reception-side communication device 10Rx.

The wireless communication module 15 includes a transmission signal processing unit 106 that performs encoding processing of data to be transmitted, an access control unit 107 that performs access control required to transmit a frame, and an antenna control unit 108 that transmits, as a wireless signal, a transmission signal from the transmission signal processing unit 106 via an antenna (not illustrated). Furthermore, the antenna control unit 108 outputs the wireless signal received via the antenna as a reception signal.

The wireless communication module 15 includes a reception signal processing unit 109 that extracts information configured as a frame from the reception signal from the antenna control unit 108, a frame analysis unit 110 that extracts information included in data in individual frames extracted by the reception signal processing unit 109, and a reception buffer 111 that temporarily stores received data.

Note that, in the configuration illustrated in FIG. 4, an arrow between individual blocks represents a flow and control of data (signal), and each block operates in cooperation with another block connected by the arrow to implement its own function. That is, for example, the fragment management unit 105 operates in cooperation with each of the frame construction unit 104, the access control unit 107, and the frame analysis unit 110 under the control of the communication control unit 103 to implement functions related to the fragment operation of the present disclosure.

### Fragment Operation of Present Disclosure

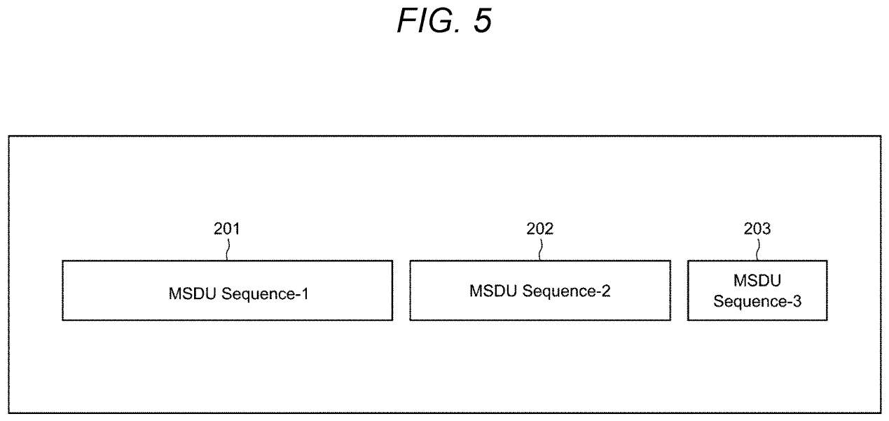

The fragment operation in the transmission-side communication device 10Tx will be described with reference to FIGS. 5 to 12. The fragment of the present disclosure indicates that transmission data, which is variable-length data such as a MAC layer service data unit (MSDU), is divided into any information lengths. Data generated by dividing the transmission data is fragmented data (fragment data). The transmission data is data to be transmitted by the transmission-side communication device 10Tx.

FIG. 5 illustrates an example in which a plurality of MSDUs having different information lengths exist as transmission data to be transmitted from the transmission-side communication device 10Tx. FIG. 5 illustrates a state in which data of three MSDUs is stored in the transmission buffer 102, and data 201 as an MSDU Sequence-1, data 202 as an MSDU Sequence-2, and data 203 as an MSDU Sequence-3 are each configured as variable-length data to which sequence numbers are individually assigned.

While those pieces of data 201 to 203 are fragmented into a certain information length (information amount) and transmitted in the fragment operation of an existing system, in the fragment operation of the present disclosure, whether or not to be fragmented is determined depending on a usage status of a transmission path. Here, the usage status of the transmission path includes a usage status of a link. The usage status of the link indicates whether or not the link is used by another device at the time when the transmission-side communication device 10Tx checks the usage status, and further indicates whether or not the link may be used by its own device. Furthermore, the usage status of the link may indicate, for how long after the time point at which the transmission-side communication device 10Tx confirms the usage status, whether the link is available or scheduled to be used by another device or its own device. That is, the usage status of the link may be regarded as indicating the duration in which the link may be used.

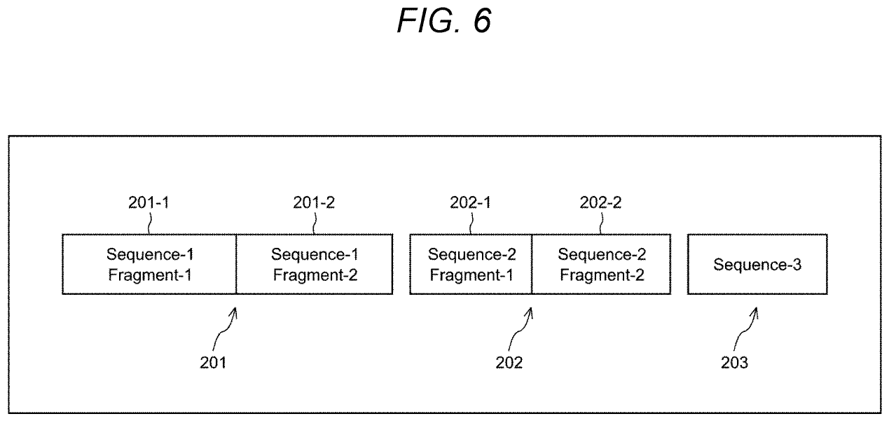

FIG. 6 is a diagram illustrating a configuration of fragmenting into any information length (information amount) according to a transmission opportunity (TXOP). FIG. 6 illustrates a process of fragmenting one MSDU as necessary to match the transmission opportunity (TXOP) of the transmission path.

In FIG. 6, the data 201 as the MSDU Sequence-1 is fragmented into two pieces of data of data 201-1 as a Sequence-1 Fragment-1 and data 201-2 as a Sequence-1 Fragment-2. The data 202 as the MSDU Sequence-2 is fragmented into two pieces of data of data 202-1 as a Sequence-2 Fragment-1 and data 202-2 as a Sequence-2 Fragment-2. The data 203 as the MSDU Sequence-3 is not fragmented. As described above, according to the fragment operation of the present disclosure, the data of the MSDU may be fragmented or may not be fragmented depending on the transmission opportunity (TXOP).

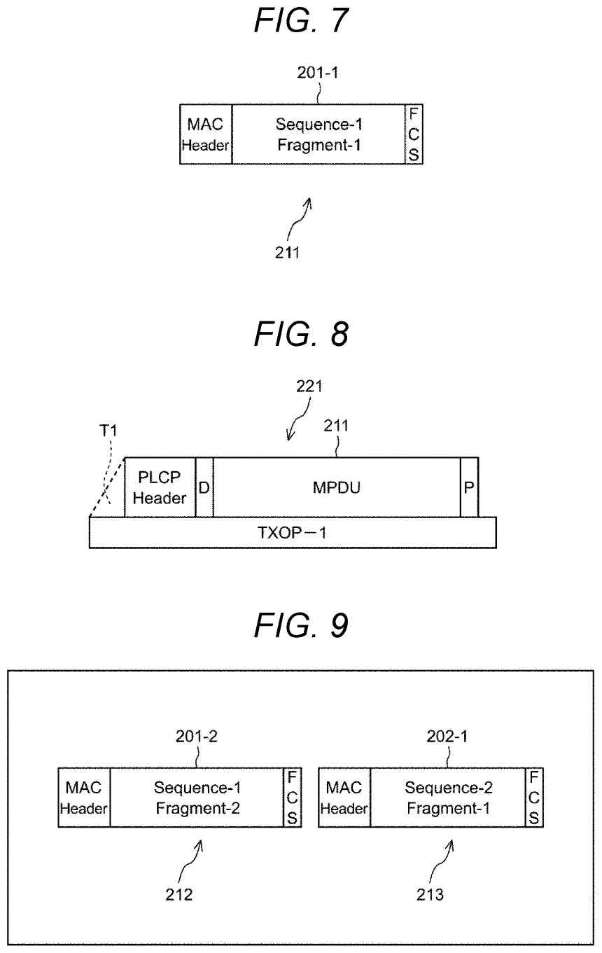

FIG. 7 is a diagram illustrating a first example in which fragmented data is configured as one frame. In FIG. 7, a frame 211 is configured by adding a predetermined MAC header and a frame check sequence (FCS) to the fragmented data 201-1 (Sequence-1, Fragment-1).

FIG. 8 is a diagram illustrating an exemplary configuration of a frame to be transmitted at a first transmission opportunity. FIG. 8 illustrates a state in which the frame 211 including the above-described fragmented data 201-1 is configured to fit in the first transmission opportunity (TXOP-1) and the transmission operation is completed within the time. In FIG. 8, a transmission waiting time according to a predetermined access control procedure is indicated by a region T1 indicated by a triangle in the drawing, and in a similar manner to a configuration of an Aggregation MPDU (A-MPDU) frame, a delimiter (D) following a predetermined physical layer convergence protocol (PLCP) header treats the frame 211 including the fragmented data 201-1 as an MPDU, thereby forming a frame 221. In the frame 221, padding (P) is added to the end as necessary. The A-MPDU frame is formed by aggregating a plurality of MPDUs into one frame.

Data subsequent to the data 201-1 is handled in a similar manner. FIG. 9 is a diagram illustrating a second example in which fragmented data is configured as one frame. In FIG. 9, a predetermined MAC header and a frame check sequence (FCS) are added to each of the fragmented data 201-2 (Sequence-1, Fragment-2) and the next fragmented data 202-1 (Sequence-2, Fragment-1), thereby forming a frame 212 and a frame 213.

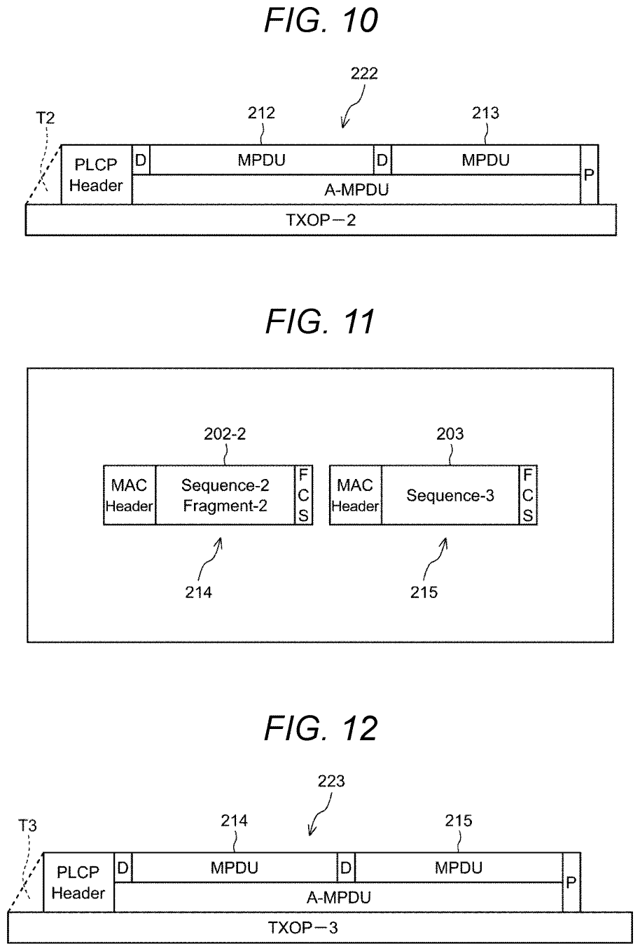

FIG. 10 is a diagram illustrating an exemplary configuration of a frame to be transmitted at a next transmission opportunity. FIG. 10 illustrates a state in which the frame 212 including the fragmented data 201-2 and the frame 213 including the fragmented data 202-1 described above are configured to fit in the next transmission opportunity (TXOP-2) and the transmission operation is completed within the time. In FIG. 10, a transmission waiting time is indicated by a region T2 indicated by a triangle in the drawing, and the frame 212 and the frame 213 including the fragmented data are treated as MPDUs, thereby forming a frame 222 having a configuration similar to that of the A-MPDU frame. In the frame 222, padding (P) is added to the end as necessary.

Data subsequent to the data 202-1 is handled in a similar manner. FIG. 11 is a diagram illustrating a third example in which fragmented data is configured as one frame. In FIG. 11, a predetermined MAC header and a frame check sequence (FCS) are added to each of the fragmented data 202-2 (Sequence-2, Fragment-2) and the unfragmented data 203 (Sequence-3), thereby forming a frame 214 and a frame 215.

FIG. 12 is a diagram illustrating an exemplary configuration of a frame to be transmitted at a further next transmission opportunity. FIG. 12 illustrates a state in which the frame 214 including the fragmented data 202-2 and the frame 215 including the unfragmented data 203 described above are configured to fit in the subsequent transmission opportunity (TXOP-3) and the transmission operation is completed within the time. In FIG. 12, a transmission waiting time is indicated by a region T3 indicated by a triangle in the drawing, and the frame 214 and the frame 215 are treated as MPDUs, thereby forming a frame 223 having a configuration similar to the configuration of the A-MPDU frame. In the frame 223, padding (P) is added to the end as necessary.

### Communication Sequence

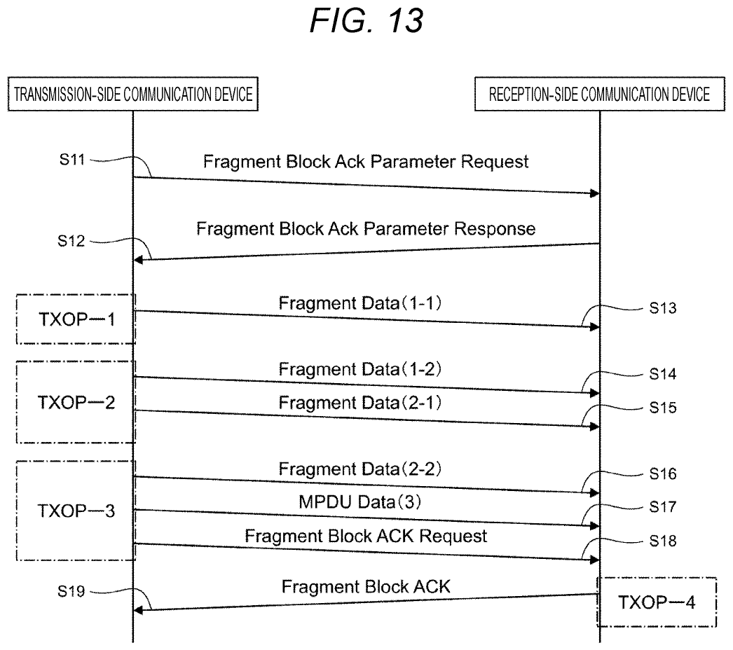

FIG. 13 is a block diagram illustrating an exemplary configuration of a communication sequence between the wireless communication devices to which the present disclosure is applied. In FIG. 13, exchange of signals exchanged between the transmission-side communication device 10Tx and the reception-side communication device 10Rx is schematically illustrated by arrows. Data transmitted and received in the communication sequence of FIG. 13 corresponds to FIGS. 5 to 12 described above, and will be described with appropriate reference.

For example, the transmission-side communication device 10Tx transmits a fragment block ACK parameter request describing desired available parameters on the transmission side (S11).

The reception-side communication device 10Rx calculates a fragment block ACK parameter that may be handled by itself in the fragment block ACK parameter request from the transmission-side communication device 10Tx, and transmits a fragment block ACK parameter response in which the respondable parameter is described (S12).

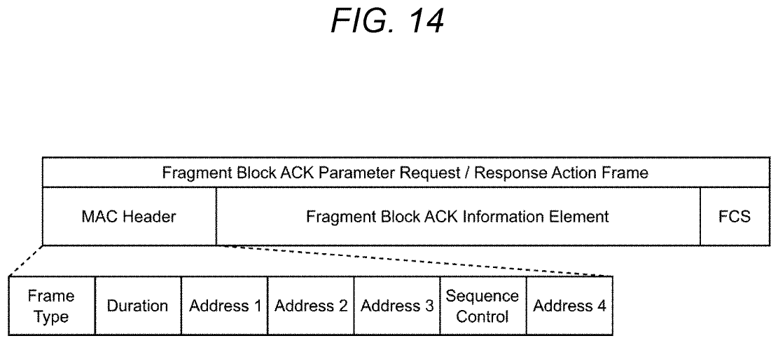

With this arrangement, the transmission-side communication device 10Tx is configured to perform a block ACK operation of the fragmented data on the basis of the parameter that may be handled by the reception-side communication device 10Rx. Note that detailed configurations of the fragment block ACK parameter request and the fragment block ACK parameter response will be described later with reference to FIGS. 14 to 16.

The transmission-side communication device 10Tx performs the fragment processing up to an information length corresponding to data falling within the transmission opportunity (TXOP-1) on the basis of the transmission opportunity (TXOP-1) that becomes available first after the access control is performed, for example. For example, among the data of the Sequence-1 (MSDU Sequence-1) as the first data to be transmitted, data having an information length that falls within the transmission opportunity (TXOP-1) is transmitted as Fragment Data (1-1) (S13). Note that the Fragment Data (1-1) transmitted at the transmission opportunity (TXOP-1) corresponds to the frame 221 described with reference to FIGS. 7 and 8.

Thereafter, the transmission-side communication device 10Tx constructs, on the basis of the next available transmission opportunity (TXOP-2), data having an information length corresponding to data falling within the transmission opportunity (TXOP-2). Here, in addition to Fragment Data (1-2), which is the remaining data that has been subjected to the fragment processing in the data of the Sequence-1 (MSDU Sequence-1), data up to Fragment Data (2-1), which is data having an information length falling within the transmission opportunity (TXOP-2) in the data of the Sequence-2 (MSDU Sequence-2) as the next data, is configured as an A-MPDU frame and transmitted (S14 and S15). Note that the Fragment Data (1-2) and the Fragment Data (2-1) transmitted at the transmission opportunity (TXOP-2) correspond to the frame 222 described with reference to FIGS. 9 and 10.

Moreover, the transmission-side communication device 10Tx constructs, on the basis of the next available transmission opportunity (TXOP-3), data having an information length corresponding to data falling within the transmission opportunity (TXOP-3). Here, in addition to Fragment Data (2-2), which is the remaining data that has been subjected to the fragment processing in the data of the Sequence-2 (MSDU Sequence-2), MPDU Data (3), which is data including all the information lengths of the data of the Sequence-3 (MSDU Sequence-3) as the next data, is configured as an A-MPDU frame and transmitted (S16 and S17). Note that the Fragment Data (2-2) and the MPDU Data (3) transmitted at the transmission opportunity (TXOP-3) correspond to the frame 223 described with reference to FIGS. 11 and 12.

Thereafter, in order to exchange ACK information, a block ACK request frame of fragmented data (fragment block ACK request) is transmitted from the transmission-side communication device 10Tx to the reception-side communication device 10Rx (S18). Here, an example is illustrated in which the block ACK request frame is included and transmitted during the time of the transmission opportunity (TXOP-3).

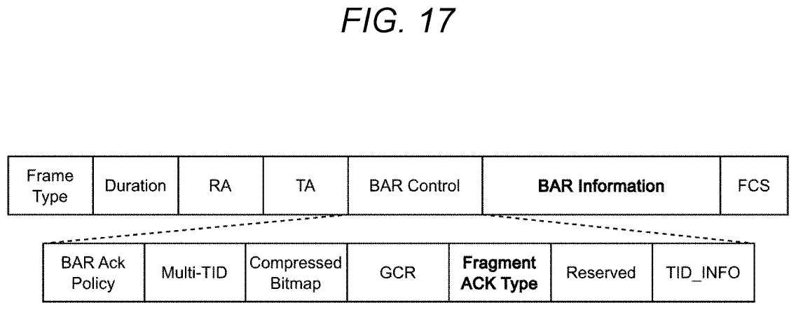

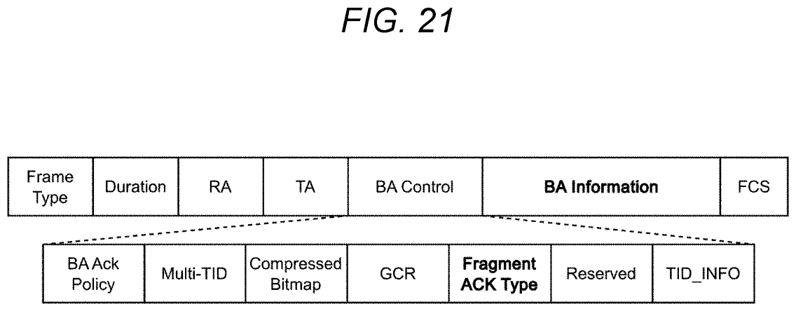

In a case where the reception-side communication device 10Rx has received the block ACK request frame from the transmission-side communication device 10Tx, it transmits a block ACK frame of the fragmented data (Fragment Block ACK) in response to the block ACK request frame (S19). Note that the reception-side communication device 10Rx may return the block ACK frame of the fragmented data when timing of a transmission opportunity (TXOP-4) is set. A detailed configuration of the block ACK request frame will be described later with reference to FIGS. 17 to 20. A detailed configuration of the block ACK frame will be described later with reference to FIGS. 21 to 24.

Note that, in a case where the reception-side communication device 10Rx has successfully received all the data from the transmission-side communication device 10Tx, it may restore the data (transmission data) before being fragmented by collecting fragment data. For example, in FIG. 13, the reception-side communication device 10Rx may collect the Fragment Data (1-1) transmitted at the transmission opportunity (TXOP-1) and the Fragment Data (1-2) transmitted at the next transmission opportunity (TXOP-2), thereby restoring the MSDU Sequence-1 from those pieces of fragment data for construction as reception data. Furthermore, the reception-side communication device 10Rx may collect the Fragment Data (2-1) transmitted at the transmission opportunity (TXOP-2) and the Fragment Data (2-2) transmitted at the transmission opportunity (TXOP-3), thereby restoring the MSDU Sequence-2 from those pieces of fragment data for construction as reception data. The reception data is data received by the reception-side communication device 10Rx.

### Frame Configuration

FIG. 14 is a diagram illustrating an exemplary configuration of the frame of the fragment block ACK parameter.

The frame of the fragment block ACK parameter is used in a request frame by which the transmission-side communication device 10Tx inquires of the reception-side communication device 10Rx about availability and in a response frame by which the reception-side communication device 10Rx responds an available parameter to the transmission-side communication device 10Tx in a case of performing block ACK in a unit of the fragmented data.

While FIG. 14 illustrates an example in which the request frame is configured as an action frame exchanged at any timing, it may be configured as an information element exchanged between the access point AP and the communication terminal STA at the time of association. Alternatively, in a case of requesting the operation of the block ACK, it may be configured as a single frame, may be configured to be added to the data frame, or may be configured to be exchanged together with any other frame as necessary.

In a case where the request frame and the response frame are configured as action frames, a fragment block ACK information element as an information element is arranged following a predetermined MAC header, and a frame check sequence (FCS) for error detection is added thereto.

The MAC header includes information such as a Frame Type indicating a format of a frame, a Duration indicating a duration, addresses Address 1 to Address 4 for identifying a sending source and a sending destination, Sequence Control in which information such as a sequence number is described, and the like.

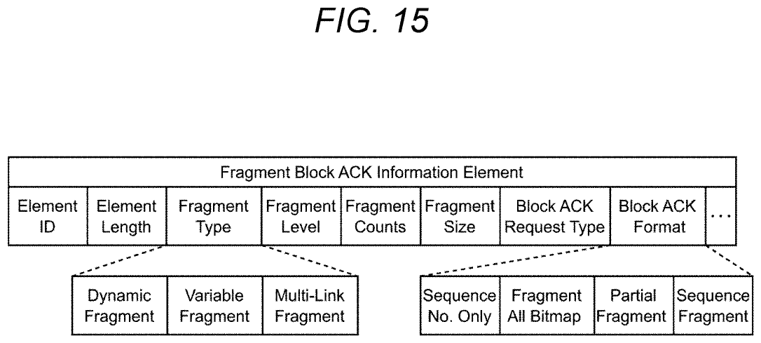

FIG. 15 is a diagram illustrating a first exemplary configuration of the fragment block ACK information element in FIG. 14.

In FIG. 15, the fragment block ACK information element includes, as information elements, parameters such as an Element ID indicating a predetermined element identifier, an Element Length indicating an information length of the element, a Fragment Type indicating an available fragment format, a Fragment Level indicating a fragment level, a Fragment Counts indicating the number of fragments, a Fragment Size indicating a size to be fragmented, a Block ACK Request Type indicating a format of the block ACK request, a Block ACK Format indicating a format of the block ACK, and the like.

For example, the Fragment Type may be configured to describe, as a fragment format, a Dynamic Fragment indicating a dynamic fragment, a Variable Fragment indicating a variable fragment, a Multi-Link Fragment indicating a fragment of a multi-link operation, and the like.

The Block ACK Format includes, as a format of the block ACK, Sequence No. Only, which is a format for making notification regarding only a sequence number, Fragment All Bitmap, which is an entire bitmap format including a fragment portion, Partial Fragment, which is a format describing only a partially fragmented portion, Sequence Fragment, which is a format for specifying and returning a fragmented sequence number portion.

Those parameters are configured such that a request frame describing a desired parameter or a corresponding parameter is transmitted from the transmission-side communication device 10Tx and a response frame describing the corresponding parameter or a parameter to be committed is returned (responded) by the reception-side communication device 10Rx that receives the request frame. For example, it may be used to exchange information indicating whether or not to receive a block ACK request frame of the fragmented data.

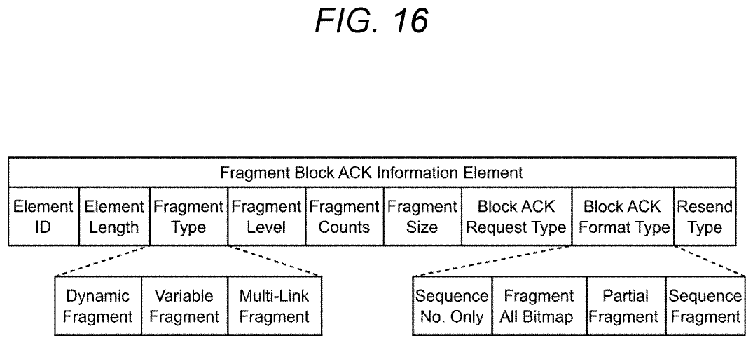

FIG. 16 is a diagram illustrating a second exemplary configuration of the fragment block ACK information element in FIG. 14.

In FIG. 16, the fragment block ACK information element includes, as information elements, parameters such as the Element ID, Element Length, Fragment Type, Fragment Level, Fragment Counts, Fragment Size, Block ACK Request Type, Block ACK Format Type, Resend Type, and the like. In a case where the configuration of FIG. 16 is compared with the configuration of FIG. 15, the Block ACK Format Type indicating a format of the block ACK and the Resend Type defining a retransmission format are arranged instead of the Block ACK Format.

The Block ACK Format Type includes Sequence No. Only, which is a format for making notification regarding only a sequence number, Fragment All Bitmap, which is an entire bitmap format including a fragment portion, Partial Fragment, which is a format describing only a partially fragmented portion, Sequence Fragment, which is a format for specifying and returning a fragmented sequence number portion, and a format to be used is designated here.

That is, among the formats of the block ACK supported by the wireless communication device 10 on the other side, the format to be used is designated and exchanged, and in a case where the format is not particularly designated, it may be defined such that the format in which the Block ACK Bitmap field is described in units of sequence numbers is transmitted in a similar manner to an existing system. This retransmission format is configured to identify whether to perform retransmission in units of sequence numbers as in the conventional system or to perform retransmission in units of fragments according to the present disclosure, and is configured to recognize in advance the capacity of the wireless communication device 10 on the other side and perform retransmission according to the capacity.

Those parameters are configured such that a request frame describing a desired parameter or a corresponding parameter is transmitted from the transmission-side communication device 10Tx and a response frame describing the corresponding parameter or a parameter to be committed is returned (responded) by the reception-side communication device 10Rx that receives the request frame. For example, it may be used at a time of exchanging information regarding retransmission in a unit of the fragmented data (information indicating whether or not to perform retransmission).

FIG. 17 is a diagram illustrating an exemplary configuration of the block ACK request frame (fragment block ACK request) of the fragmented data.

In FIG. 17, the configuration of the block ACK request frame follows the configuration of the existing system due to the need to maintain compatibility with the wireless LAN system according to the existing system. The block ACK request frame includes the Frame Type indicating a format of the frame, the Duration indicating a duration, an RA indicating a reception address, a TA indicating a transmission address, a BAR Control indicating control information of the block ACK request frame, BAR information indicating a parameter of the block ACK request, and a frame check sequence (FCS) for error detection.

The BAR Control includes parameters such as BAR Ack Policy, Multi TID, Compressed Bitmap, GCR, Fragment ACK Type, TID_INFO, and the like. The Fragment ACK Type indicates a format of the block ACK of the fragmented data according to the present disclosure, and indicates a format in which a request to the BAR Information is issued. The BAR information may include information for identifying the sequence of the fragmented data.

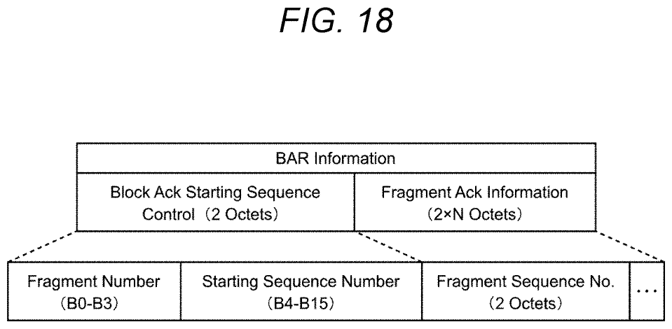

FIG. 18 is a diagram illustrating a first example of description of the BAR information in FIG. 17.

In FIG. 18, the BAR information has a variable length, and in a similar manner to the existing system, the BAR information includes a Fragment Number and a Starting Sequence Number as Block Ack Starting Sequence Control. In addition, Fragment Ack Information is written as many as the number of sequence numbers of 2 octets. This format is used in a case where, for example, a part of the sequence number space is fragmented.

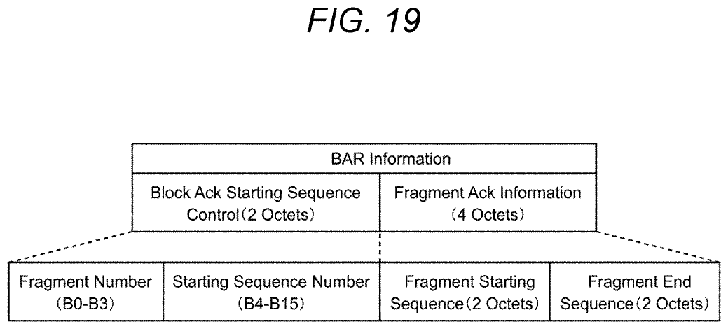

FIG. 19 is a diagram illustrating a second example of the description of the BAR information in FIG. 17.

In FIG. 19, the BAR information has a variable length, and in a similar manner to the existing system, the BAR information includes a Fragment Number and a Starting Sequence Number as the Block Ack Starting Sequence Control. In addition, the Fragment Ack Information indicates, as fragment information, a Fragment Starting Sequence indicating a start sequence number to a Fragment End Sequence indicating an end sequence number, and information of 2 octets is described in each of the sequences. This format is used in a case where, for example, a large portion of the sequence number space is fragmented. That is, the Fragment Starting Sequence and the Fragment End Sequence indicate a range of the sequence of the fragmented data.

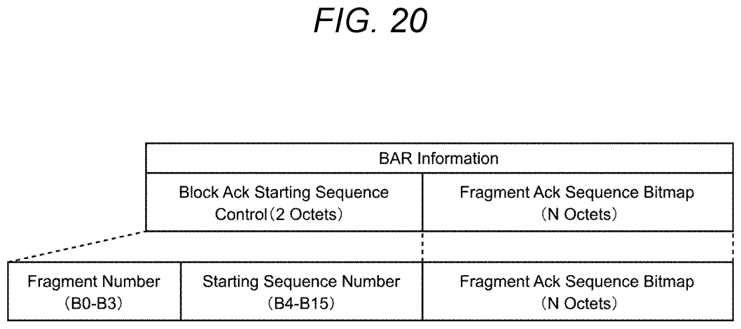

FIG. 20 is a diagram illustrating a third example of the description of the BAR information in FIG. 17.

In FIG. 20, the BAR information has a variable length, and in a similar manner to the existing system, the BAR information includes a Fragment Number and a Starting Sequence Number as the Block Ack Starting Sequence Control. The fragmented sequence numbers are sequentially described as a Fragment Ack Sequence Bitmap, which is a bitmap format of sequence numbers, and the length of the bitmap is configured as a variable length as necessary. This format is used in a case where, for example, fragmented sequence numbers are discontinuously present.

FIG. 21 is a diagram illustrating an exemplary configuration of the block ACK frame (fragment block ACK) of the fragmented data.

In FIG. 21, the configuration of the block ACK frame follows the configuration of the existing system due to the need to maintain compatibility with the wireless LAN system according to the existing system. The block ACK frame includes the Frame Type indicating a format of the frame, the Duration indicating a duration, the RA indicating a reception address, the TA indicating a transmission address, a BA Control indicating control information of the block ACK, BA information indicating a parameter of the block ACK, and a frame check sequence (FCS) for error detection.

The BA Control includes parameters such as BA Ack Policy, Multi TID, Compressed Bitmap, GCR, Fragment ACK Type, TID_INFO, and the like. The Fragment ACK Type indicates a format of the block ACK of the fragmented data according to the present disclosure, and indicates a format in which a request to the BA Information is issued. The BA information may include information indicating a receipt status of the sequence of the fragmented data.

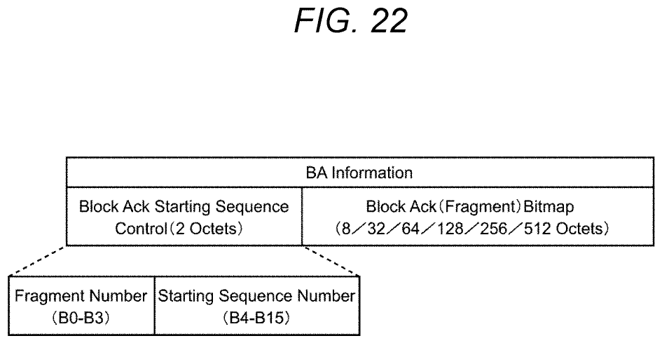

FIG. 22 is a diagram illustrating a first example of the description of the BA information in FIG. 21.

In FIG. 22, the BA Control includes a Fragment Number and a Starting Sequence Number as the Block Ack Starting Sequence Control in a similar manner to the existing system. Moreover, a Block Ack Bitmap space is described as a bitmap format including a fragment space. For example, in a case where the maximum number of fragments is determined to be four, a bitmap is formed such that the lower two bits of the bitmap are diverted to fragment information in the Block Ack Bitmap. For example, in a case where many of the sequence numbers are fragmented, notification may be made in such a format.

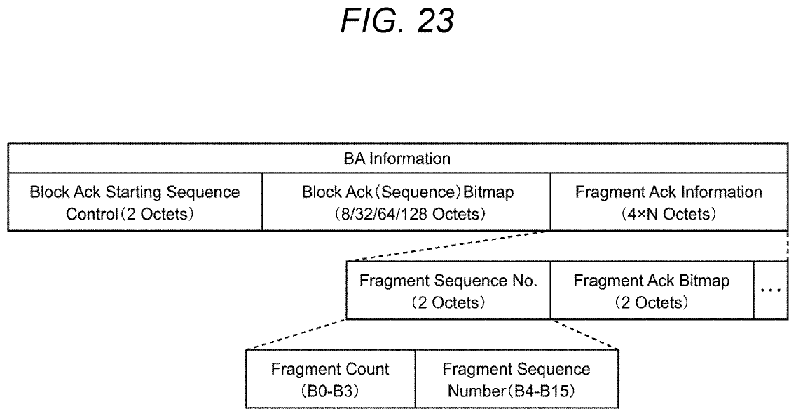

FIG. 23 is a diagram illustrating a second example of the description of the BA information in FIG. 21.

In FIG. 23, the BA Control includes the Block Ack Starting Sequence Control in a similar manner to the existing system. Moreover, a Block Ack Bitmap space and a Fragment Ack Information space indicating a receipt status of the fragmented sequence are added.

The Fragment Ack Information space includes a Fragment Sequence No. indicating a fragmented sequence number, and a Fragment Ack Bitmap indicating a receipt status of the fragment data of the sequence number. The Fragment Sequence No. includes a Fragment Count indicating the number of fragments, and a Fragment Sequence Number indicating a sequence number actually fragmented. That is, this Fragment Ack Information is prepared according to the number of fragmented sequence numbers.

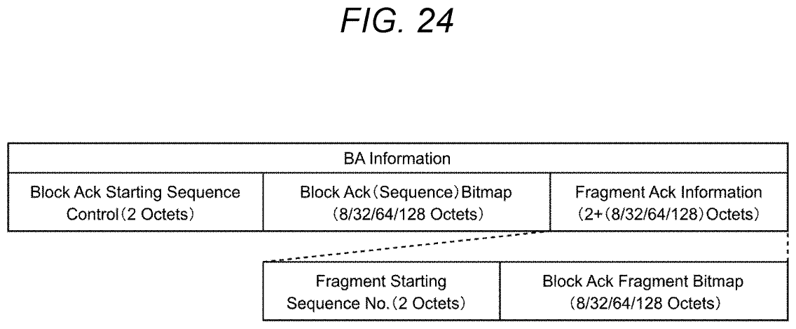

FIG. 24 is a diagram illustrating a third example of the description of the BA information in FIG. 21.

In FIG. 24, the BA Control includes the Block Ack Starting Sequence Control in a similar manner to the existing system. Moreover, a Block Ack Bitmap space and a Fragment Ack Information space indicating a receipt status of the fragmented sequence are added, and it is used in a case where, for example, fragmented sequences are distributed.

The Fragment Ack Information space includes a Fragment Starting Sequence No. indicating a sequence number at which fragmentation is started, and a Block Ack Fragment Bitmap described in the Block Ack Bitmap format in a unit of fragmented data for the sequence number and subsequent sequence numbers.

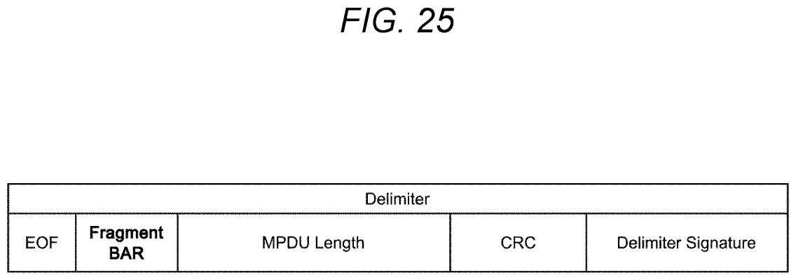

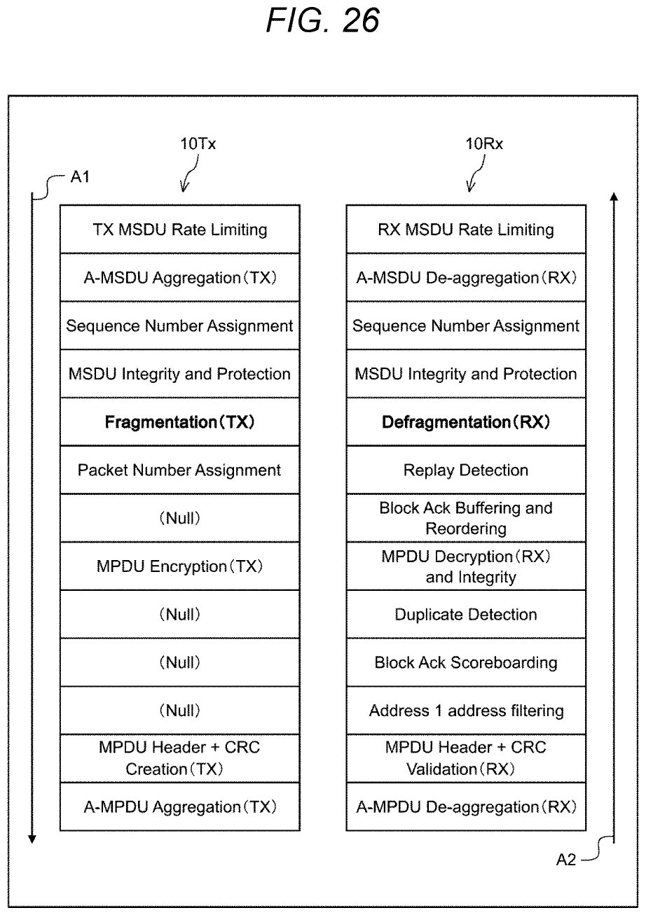

FIG. 25 is a diagram illustrating an exemplary configuration of a delimiter including a block ACK request in a fragment unit.

FIG. 25 illustrates an exemplary configuration in which a reserved portion of the delimiter (Delimiter) included in the A-MPDU frame is applied as an identifier for requesting a block ACK in a fragment unit. That is, this configuration illustrates an exemplary configuration in which the block ACK request frame in a fragment unit is simplified.

As described above, by describing and transmitting the block ACK request in a fragment unit with respect to the A-MPDU frame, the transmission-side communication device 10Tx is enabled to prompt the reception-side communication device 10Rx to return (respond) the block ACK frame describing the receipt information in a unit of fragmented data without transmitting the block ACK request frame.

### Signal Processing Structure in Device

The signal processing performed by the wireless communication device 10 in the wireless LAN system will be described, and for comparison, a structure of the signal processing in the existing system will be described, and then a structure of the signal processing according to the present disclosure will be described. FIG. 26 is a diagram illustrating a structure of signal processing in a device in the existing wireless LAN system.

In FIG. 26, each signal processing performed in the device is represented by a square, and the left side in the drawing illustrates a flow of signal processing processed in the transmission-side communication device 10Tx that transmits data, which is performed in order from the top to the bottom in the drawing as indicated by an arrow A1. In the wireless LAN system of the existing system, processing of TX MSDU Rate Limiting, A-MSDU Aggregation (TX), Sequence Number Assignment, MSDU Integrity and Protection, Fragmentation (TX), Packet Number Assignment, MPDU Encryption (TX), MPDU Header+CRC Creation (TX), and A-MPDU Aggregation (TX) is performed in that order in the transmission-side communication device 10Tx.

In FIG. 26, the right side in the drawing illustrates a flow of signal processing processed in the reception-side communication device 10Rx that receives data, which is performed in order from the bottom to the top as indicated by an arrow A2. In the wireless LAN system of the existing system, processing of A-MPDU De-aggregation (RX), MPDU Header+CRC Validation (RX), Address 1 address Filtering, Block Ack Scoreboarding, Duplicate Detection, MPDU Decryption (RX) and Integrity, Block Ack Buffering and Reordering, Replay Detection, Defragmentation (RX), MSDU Integrity and Protection, Sequence Number Assignment, A-MSDU De-aggregation (RX), and RX MSDU Rate Limiting is performed in that order in the reception-side communication device 10Rx.

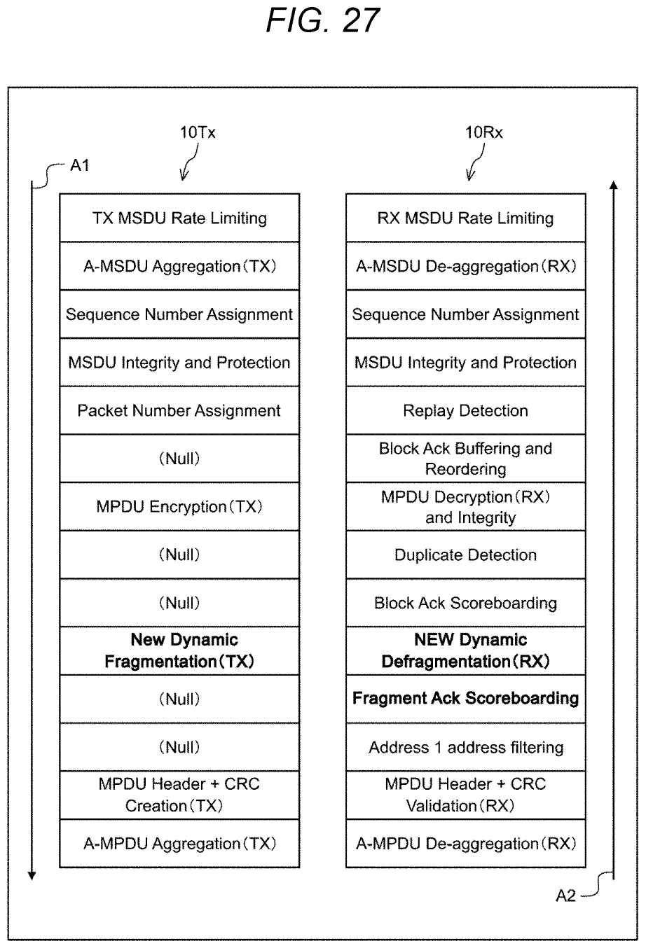

FIG. 27 is a diagram illustrating a structure of signal processing in a device in the wireless LAN system according to the present disclosure. In FIG. 27, in a similar manner to FIG. 26, the left side in the drawing illustrates a flow of signal processing in the transmission-side communication device 10Tx in the order from the top to the bottom in the drawing, and the right side in the drawing illustrates a flow of signal processing in the reception-side communication device 10Rx in the order from the bottom to the top in the drawing.

In the signal processing according to the present disclosure, conventional fragmentation may be individually performed, or the processing may be performed at a later stage to perform the fragmentation on the basis of a parameter added in processing at a later stage. That is, while the processing of Fragmentation (TX) is performed after the processing of TX MSDU Rate Limiting, A-MSDU Aggregation (TX), Sequence Number Assignment, and MSDU Integrity and Protection is performed in the transmission-side communication device 10Tx according to the existing system, the processing of Packet Number Assignment and MPDU Encryption (TX) is performed according to the present disclosure. Then, the processing of Dynamic Fragmentation (TX) based on the multi-link operation may be performed. Then, the processing of MPDU Header+CRC Creation (TX) and A-MPDU Aggregation (TX) is performed, and a frame to be transmitted is constructed.

Meanwhile, in the reception-side communication device 10Rx, the processing of A-MPDU De-aggregation (RX), MPDU Header+CRC Validation (RX), and Address 1 address Filtering is performed in a similar manner to the existing system. In the present disclosure, processing of Fragment Ack Scoreboarding and Dynamic Defragmentation (RX) may be sandwiched therebetween. Then, the processing of Block Ack Scoreboarding, Duplicate Detection, MPDU Decryption (RX) and Integrity, Block Ack Buffering and Reordering, and Replay Detection in the flow of the existing system may be performed. Note that Fragment Ack Scoreboarding and Dynamic Defragmentation (RX) may include an operation of managing Fragment Data such as Duplicate Detect in a fragmented portion as necessary.

Additionally, while Defragmentation (RX) required in the fragmentation according to the existing system may be processed in this portion, it may not be processed in this portion if unnecessary. Moreover, the processing of MSDU Integrity and Protection, Sequence Number Assignment, A-MSDU De-aggregation (RX), and RX MSDU Rate Limiting may be performed.

### Operation of Wireless Communication Device

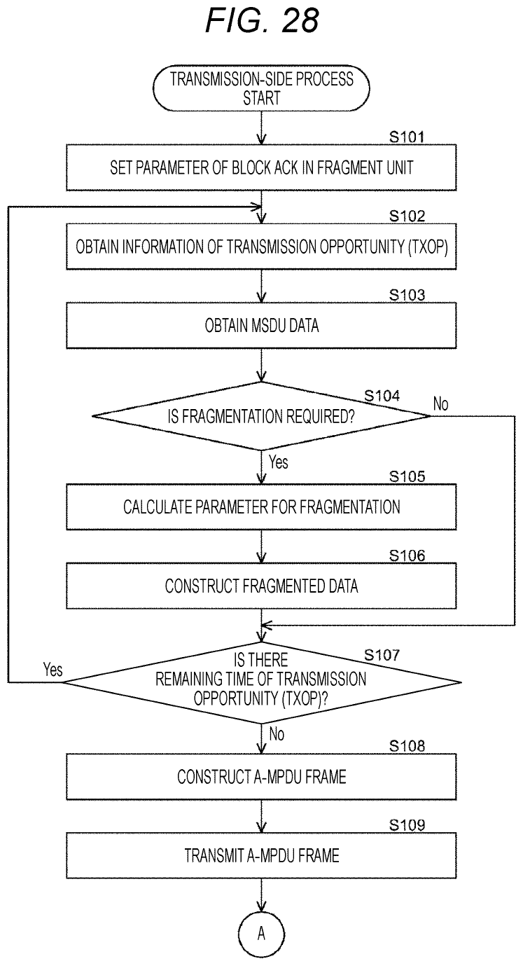

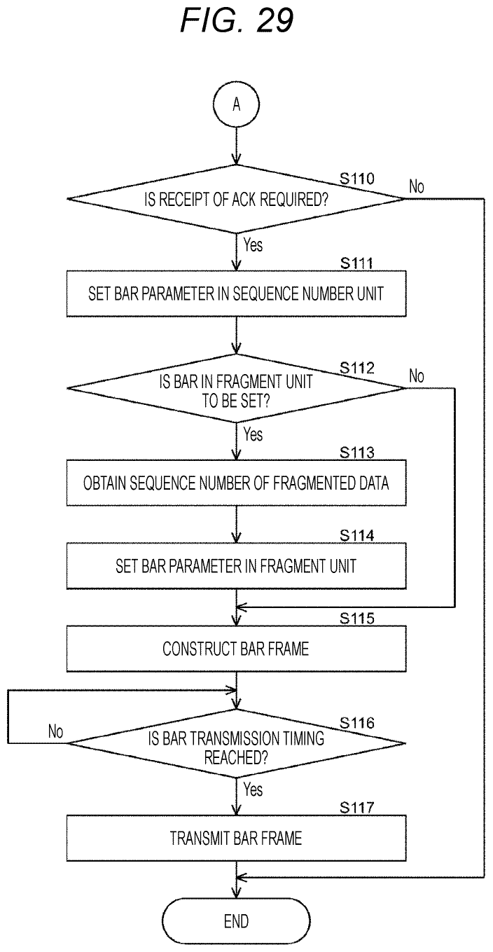

A flow of a transmission-side process to be performed by the transmission-side communication device 10Tx will be described with reference to a flowchart of FIGS. 28 and 29.

The transmission-side communication device 10Tx exchanges parameters with the reception-side communication device 10Rx in advance, and sets parameters related to necessity of block ACK in a unit of the fragmented data, a frame format for exchange, and the like (S101). Furthermore, information regarding a transmission opportunity (TXOP) is obtained when the transmission data is stored (S102), and MSDU data to be transmitted first is obtained (S103).

Then, it is determined whether or not fragmentation needs to be performed on the basis of the remaining time of the transmission opportunity (TXOP) and the parameter related to the information length of the MSDU data to be transmitted (S104). If it is determined that the fragmentation is needed (Yes in S104), a parameter (information length, etc.) at the time of dynamically performing the fragmentation is calculated (S105), and data fragmented with the calculated information length is constructed (S106). If it is determined that the fragmentation is not needed (No in S104), steps S105 and S106 are skipped.

At this time, if there is a remaining time of the transmission opportunity (TXOP) (Yes in S107), the process returns to step S102, and the process of adding the remaining fragment data and the MSDU data to be transmitted next is performed (S102 to S106). Then, if there is no remaining time of the transmission opportunity (TXOP) (No in S107), the fragmented data or the unfragmented data is constructed as an A-MPDU frame (S108), and the constructed A-MPDU frame is transmitted (S109). The A-MPDU frame transmitted from the transmission-side communication device 10Tx is received by the reception-side communication device 10Rx.

The transmission-side communication device 10Tx determines whether or not receipt of ACK is required (S110). If it is determined that the receipt of ACK is required (Yes in S110), a block ACK request (BAR) parameter in a unit of the transmitted sequence number is set (S111).

Moreover, it is determined whether or not to set a block ACK request (BAR) in a fragment unit (S112). If the block ACK request in a fragment unit is to be set (Yes in S112), the sequence number of the fragmented data is obtained (S113), and the BAR parameter is set in a fragment unit (S114). If it is determined not to set the block ACK request in a fragment unit (No in S112), steps S113 and S114 are skipped.

Then, a block ACK request frame is constructed (S115). In the block ACK request frame, a BAR parameter in a unit of at least one of a unit of the sequence number or a unit of the fragment is set (S111 to S114). If transmission timing of the block ACK request is reached (Yes in S116), the block ACK request frame is transmitted (S117). The block ACK request frame transmitted from the transmission-side communication device 10Tx is received by the reception-side communication device 10Rx.

Note that, if it is determined that the receipt of ACK is not required (No in S110), steps S111 to S117 are skipped. By performing such a series of processing, the transmission-side communication device 10Tx is enabled to transmit the data frame (A-MPDU frame), and to transmit the block ACK request frame as necessary.

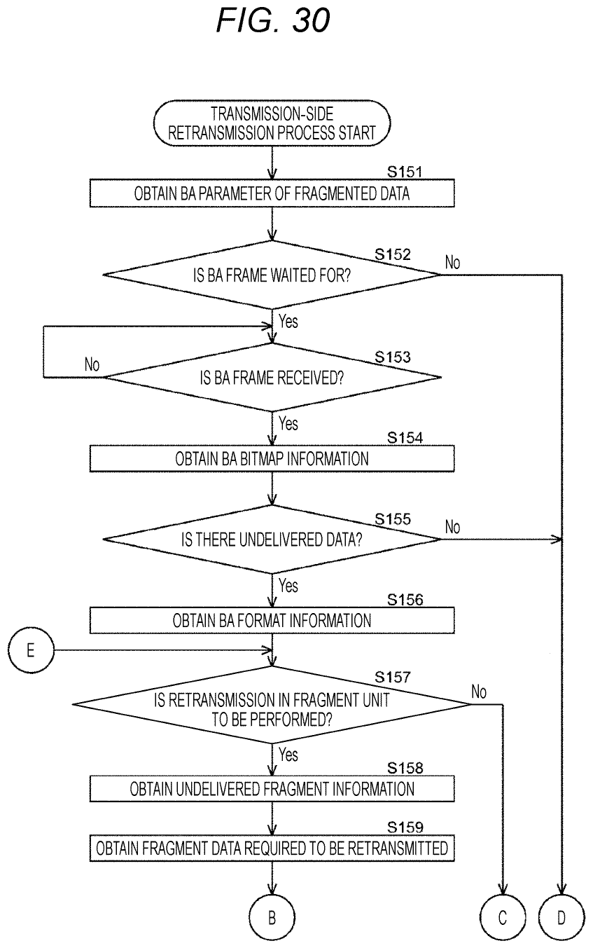

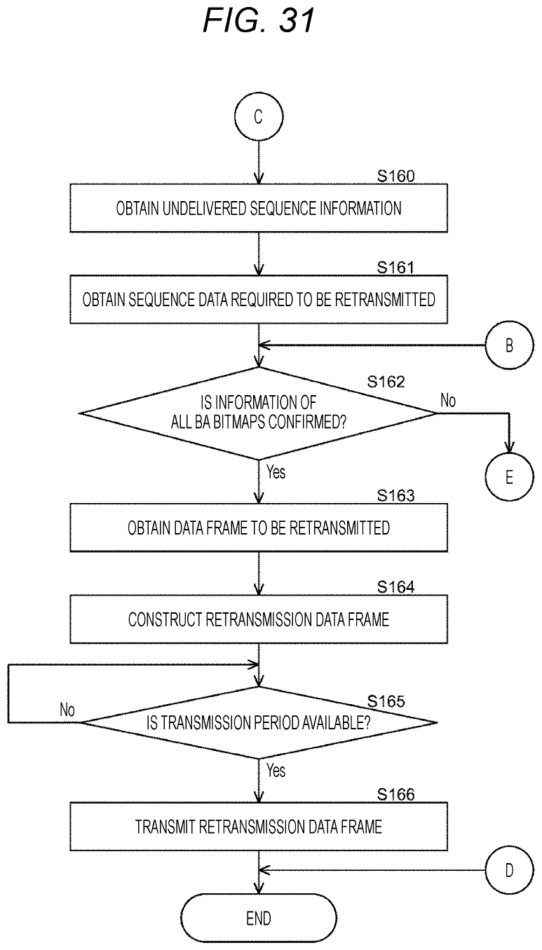

Next, a flow of a transmission-side retransmission process to be performed by the transmission-side communication device 10Tx will be described with reference to a flowchart of FIGS. 30 and 31.

The transmission-side communication device 10Tx obtains a parameter at a time of receiving block ACK (BA) of fragmented data and a format at a time of performing retransmission by itself (S151). If the transmission-side communication device 10Tx stands by for a block ACK frame from the reception-side communication device 10Rx (Yes in S152), it performs processing of step S154 and subsequent steps when the block ACK frame is received (Yes in S153).

That is, the parameter of the BA bitmap (Block Ack Bitmap) included in the block ACK frame of FIG. 21 is obtained (S154), and if there is undelivered data to the reception-side communication device 10Rx (Yes in S155), format information of the block ACK is obtained from the Type field of the block ACK frame (S156). Here, if information in a fragment unit is stored and retransmission is set to be performed in a fragment unit in its own device (Yes in S157), information regarding the undelivered fragment data is obtained (S158), the fragment data that needs to be retransmitted is specified on the basis of the information, and the data is obtained (S159).

On the other hand, if information in a sequence number unit is stored in a similar manner to the existing system or retransmission is set not to be performed in a fragment unit in its own device (No in S157), information regarding the undelivered sequence number is obtained (S160), the data that needs to be retransmitted (unfragmented MSDU data) is specified on the basis of the information, and the data is obtained (S161).

Subsequent to step S159 or S161, it is determined whether the information of all the BA bitmaps has been confirmed (S162), and if the confirmation of the information has not been complete (No in S162), the processing related to the fragment unit (S158 and S159) or the processing related to the sequence number unit (S160 and S161) is repeated for the information of all the BA bitmaps. Then, if the confirmation of the information is complete and all the undelivered data is specified (Yes in S162), a data frame to be retransmitted is obtained (S163), and a retransmission data frame is constructed as, for example, an A-MPDU frame (S164).

Presence of a transmission opportunity (TXOP) is grasped to determine whether or not it is a period in which transmission may be performed (S165), and if it is the period in which transmission may be performed (Yes in S165), a retransmission data frame is transmitted (S166). Note that, also in the transmission-side retransmission process, in a similar manner to the transmission-side process, data until the transmission opportunity (TXOP) expires may be constructed as an A-MPDU frame. The retransmission data frame transmitted from the transmission-side communication device 10Tx is received by the reception-side communication device 10Rx that has transmitted the block ACK frame.

Note that, if the block ACK frame is not waited for (No in S152) or there is no undelivered data (No in S155), steps S153 to S166 or steps S156 to S166 are skipped. By performing such a series of processing, the transmission-side communication device 10Tx is enabled to transmit the retransmission data frame including the undelivered data to the reception-side communication device 10Rx that has transmitted the block ACK frame.

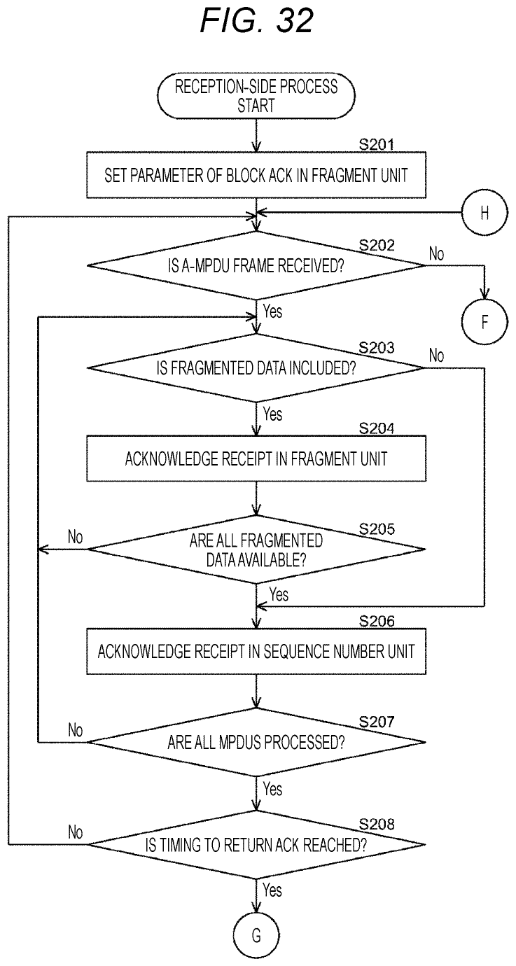

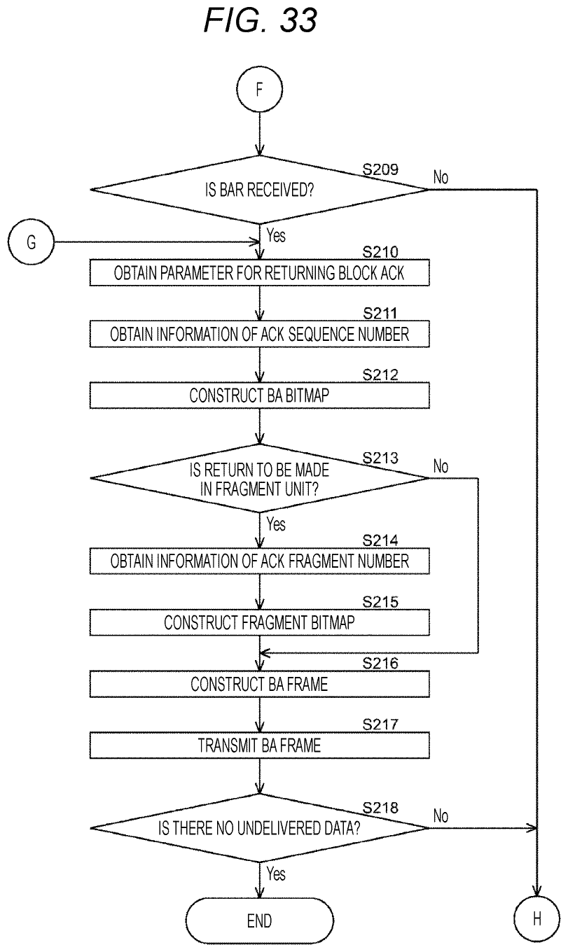

Next, a flow of a reception-side process to be performed by the reception-side communication device 10Rx will be described with reference to a flowchart of FIGS. 32 and 33.

The reception-side communication device 10Rx exchanges parameters with the transmission-side communication device 10Tx in advance, and sets parameters related to necessity of block ACK in a unit of the fragmented data, a frame format for exchange, and the like (S201).

If the A-MPDU frame addressed to the reception-side communication device 10Rx is received from the transmission-side communication device 10Tx (Yes in S202) and the A-MPDU frame includes fragmented data (Yes in S203), the reception-side communication device 10Rx acknowledges the receipt in a fragment unit (S204). This receipt acknowledgment is repeated until all the pieces of fragmented data are available (No in S205, S203 to S204), and if all the pieces of fragmented data are available, receipt acknowledgment is performed in a sequence number unit (S206).

Note that, in a case where the management is performed in a sequence number unit in a similar manner to the existing system, the management in the fragment unit is not performed (No in S203), and the receipt is acknowledged in the sequence number unit (S206). If the data processing in all the MPDU units is not complete (No in S207), the series of processing returns to step S203 and is repeated. Then, if all the processing is complete (Yes in S207), the process returns to step S202, and the reception processing of the A-MPDU frame is performed until the timing to return the ACK arrives (Yes in S208).

If the block ACK request frame is received from the transmission-side communication device 10Tx (No in S202, Yes in S209) or if the timing to return the ACK arrives (Yes in S208), the reception-side communication device 10Rx obtains a parameter for returning the block ACK (S210), and identifies the format of the block ACK specified by the block ACK request.

Furthermore, the information of the ACK sequence number of which the reception has been acknowledged is obtained (S211), and the obtained information is constructed as BA bitmap information of the block ACK (S212). Moreover, in a case of returning the block ACK information in the fragment unit (Yes in S213), information regarding the ACK fragment number is obtained (S214), and the obtained information is constructed as fragment bitmap information (S215). That is, the information in the bitmap format of the sequence number is constructed in the same format as the existing system (S211 and S212), and the information in the bitmap format of the fragmented data is further added (S214 and S215).

The reception-side communication device 10Rx constructs a block ACK frame on the basis of the information obtained by the series of processing (S216), and transmits the constructed block ACK frame (S217). The block ACK frame transmitted from the reception-side communication device 10Rx is received by the transmission-side communication device 10Tx that has transmitted the A-MPDU frame. Then, if all the data reception is complete and there is no more undelivered data (Yes in S218), the series of processing is terminated. Note that, if there is still undelivered data (No in S218) or if the block ACK request frame is not received (No in S209), the process returns to step S202, and the reception processing of the A-MPDU frame is performed. By performing such a series of processing, the reception-side communication device 10Rx is enabled to receive the data frame (A-MPDU frame), and to return the block ACK frame.

As described above, under the control of the control unit (e.g., communication control unit 103 in FIG. 4) of the wireless communication module 15, the transmission-side communication device 10Tx according to the present disclosure may divide the transmission data (e.g., MSDU Sequence-1 in FIG. 5) to generate first data and second data (e.g., Sequence-1 Fragment-1 and Sequence-1 Fragment-2 in FIG. 6), transmit the data frame (e.g., frame 221 in FIG. 8 and frame 222 in FIG. 10) including the first data or the second data, and receive the acknowledgement response frame (e.g., block ACK frame in FIG. 21) including the receipt information (e. g., Block Ack Bitmap in FIG. 22, etc.) indicating the receipt status of the first data or the second data transmitted from the reception-side communication device 10Rx that has received the data frame. Furthermore, under the control of the control unit (e.g., communication control unit 103 in FIG. 4) of the wireless communication module 15, the transmission-side communication device 10Tx according to the present disclosure constructs an acknowledgement response request frame (e.g., block ACK request frame in FIG. 17) including first specification information for specifying the first data or second specification information for specifying the second data (e.g., Fragment Sequence Number in FIG. 18, etc.), and transmits it to the reception-side communication device 10Rx, thereby being enabled to receive the acknowledgement response frame (e. g., block ACK frame in FIG. 21) transmitted from the reception-side communication device 10Rx.

Furthermore, under the control of the control unit (e.g., communication control unit 103 in FIG. 4) of the wireless communication module 15, the reception-side communication device 10Rx according to the present disclosure may receive the data frame (e.g., frame 221 in FIG. 8 or frame 222 in FIG. 10) including the first data or the second data (e.g., Sequence-1 Fragment-1 or Sequence-1 Fragment-2 in FIG. 6) generated by dividing the transmission data (e.g., MSDU Sequence-1 in FIG. 5) transmitted from the transmission-side communication device 10Tx, restore the transmission data (e.g., MSDU Sequence-1 in FIG. 5) from the first data and the second data (e.g., Sequence-1 Fragment-1 and Sequence-1 Fragment-2 in FIG. 6) obtained from the data frame to construct it as reception data, and transmit, to the transmission-side communication device 10Tx, the acknowledgement response frame (e.g., block ACK frame in FIG. 21) including the receipt information (e.g., Block Ack Bitmap in FIG. 22, etc.) indicating the receipt status of the first data or the second data. Furthermore, in a case where the acknowledgement response request frame (e.g., block ACK request frame in FIG. 17) including the first specification information for specifying the first data or the second specification information for specifying the second data (e.g., Fragment Sequence Number in FIG. 18, etc.) transmitted from the transmission-side communication device 10Tx is received, the reception-side communication device 10Rx may construct and transmit the acknowledgement response frame (e.g., block ACK frame in FIG. 21) on the basis of the information included in the acknowledgement response request frame.

That is, according to the present disclosure, the reception-side communication device 10Rx fragments and transmits data with any information length, whereby the data may be efficiently transmitted according to the transmission opportunity of the transmission path. Furthermore, according to the present disclosure, the reception-side communication device 10Rx returns the block ACK frame in a unit of the fragmented data, whereby the transmission-side communication device 10Tx is enabled to perform retransmission in a retransmission unit smaller than a unit of the sequence number, which may improve the utilization efficiency of the transmission path.

According to the present disclosure, the transmission-side communication device 10Tx may describe and transmit, to the reception-side communication device 10Rx, information for specifying a fragmented sequence number as the information regarding the block ACK request frame. With this arrangement, the reception-side communication device 10Rx may confirm the receipt status of the individual fragmented data only for the fragmented data portion from the information for specifying the fragmented sequence number, and may return the block ACK frame including the receipt information indicating the receipt status.

Furthermore, the information described in the block ACK frame may include information for specifying the fragmented sequence number and information (receipt information) indicating the individual acknowledgment data. With this arrangement, the receipt status of the fragmented portion may be returned in the block ACK frame without occupying the space of all sequence numbers with the receipt status of the fragmented data as information in the bitmap format. The transmission-side communication device 10Tx may specify undelivered fragmented data among the fragmented sequence numbers described in the block ACK frame, and may perform retransmission of only the data of the portion. In this manner, by acknowledging receipt in a unit of the fragmentation, only required fragmented data may be retransmitted while avoiding retransmission of all pieces of data before being fragmented, which may improve the utilization efficiency of the transmission path.

According to the present disclosure, the reception-side communication device 10Rx describes only the information regarding the sequence number in the case where the pieces of the fragmented data are available, whereby the fragmented receipt receipt information may be simplified, and the information of the block ACK frame may be optimized. According to the present disclosure, the transmission-side communication device 10Tx constructs an aggregated frame (A-MPDU frame) including fragmented data, whereby a frame structure including an error detection code is formed, and the receipt of acknowledged in the unit of the fragmented data.

Note that the technique disclosed in Patent Document 1 determines a fragmentation level by transmitting an Add Block Ack (ADDBA) request frame from a transmitter to a receiver to return an ADDBA response frame from the receiver to the transmitter. However, the technique disclosed in Patent Document 1 is not configured such that detailed parameters related to the fragment are exchanged between the transmitter and the receiver to specifically determine the parameter of the fragment, which may deteriorate the utilization efficiency of the transmission path.

### Variations

### <Multi-Link Operation>

As illustrated in FIG. 2, the wireless communication device 10 according to the present disclosure may perform the multi-link operation using a plurality of frequency bands (links). That is, the transmission-side communication device 10Tx may perform the multi-link operation together with the fragment operation according to the present disclosure, and may transmit the data frame including the fragmented data via the plurality of links. The reception-side communication device 10Rx may receive the data frame via the plurality of links, and may restore the data (transmission data) before being fragmented from the fragment data extracted from the data frame.

### Exemplary Configuration of Computer

The series of processing described above may be performed by hardware, or may be performed by software. In a case where the series of processing is performed by software, a program included in the software is installed from a program recording medium on a computer incorporated in dedicated hardware, a general-purpose personal computer, or the like.

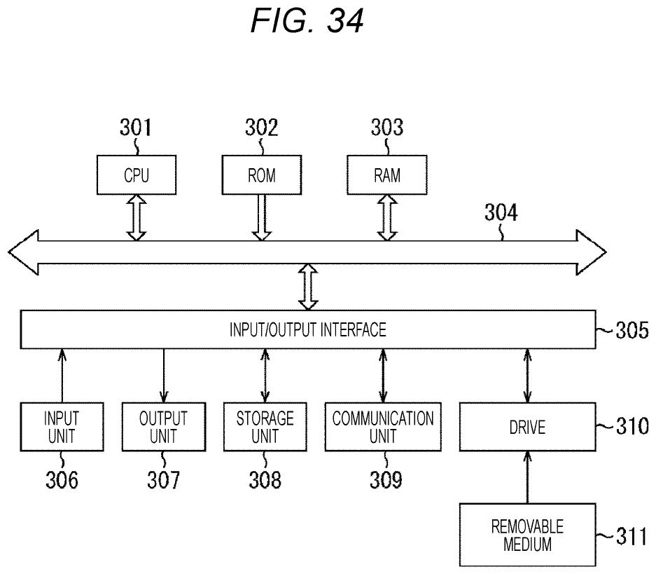

FIG. 34 is a block diagram illustrating an exemplary configuration of the hardware of the computer that performs the series of processing described above by means of the program.

A central processing unit (CPU) 301, a read only memory (ROM) 302, and a random access memory (RAM) 303 are connected to each other by a bus 304.

The bus 304 is further connected with an input/output interface 305. To the input/output interface 305, an input unit 306 including a keyboard, a mouse, and the like, and an output unit 307 including a display, a speaker, and the like are connected. Furthermore, to the input/output interface 305, a storage unit 308 including a hard disk, a nonvolatile memory, and the like, a communication unit 309 including a network interface and the like, and a drive 310 that drives a removable medium 311 are connected.

In the computer configured as described above, for example, the CPU 301 loads a program stored in the storage unit 308 into the RAM 303 via the input/output interface 305 and the bus 304, and executes the program, whereby the series of processing described above is performed.

The program to be executed by the CPU 301 is provided, for example, by being recorded on the removable medium 311 or via a wired or wireless transmission medium such as a local area network, the Internet, or digital broadcasting, and is installed on the storage unit 308.

Note that the program to be executed by the computer may be a program that performs processing in a time series according to the order described in the present specification, or may be a program that performs processing in parallel or at necessary timing such as when a call is made.

### Application Examples

The present technology may be applied to various products. For example, the wireless communication device 10 in FIG. 3 may be implemented as a mobile terminal such as a smartphone, a tablet personal computer (PC), a laptop PC, a portable game terminal, or a digital camera, a fixed terminal such as a television receiver, a printer, a digital scanner, or network storage, or an in-vehicle terminal such as a car navigation device. Furthermore, the wireless communication device 10 may be implemented as a machine to machine communication (M2M) terminal such as a smart meter, a vending machine, a remote monitoring device, a point of sale (POS) terminal, or the like. Moreover, the wireless communication device 10 may be a wireless communication module (e.g., integrated circuit module including one die) mounted on those terminals.

On the other hand, for example, the wireless communication device 10 in FIG. 3 may be implemented as a wireless LAN AP (wireless base station) having a router function or not having a router function. Furthermore, the wireless communication device 10 may be implemented as a mobile wireless LAN router. Moreover, the wireless communication device 10 may be a wireless communication module (e.g., integrated circuit module including one die) mounted on those devices.

### Exemplary Configuration of Smartphone

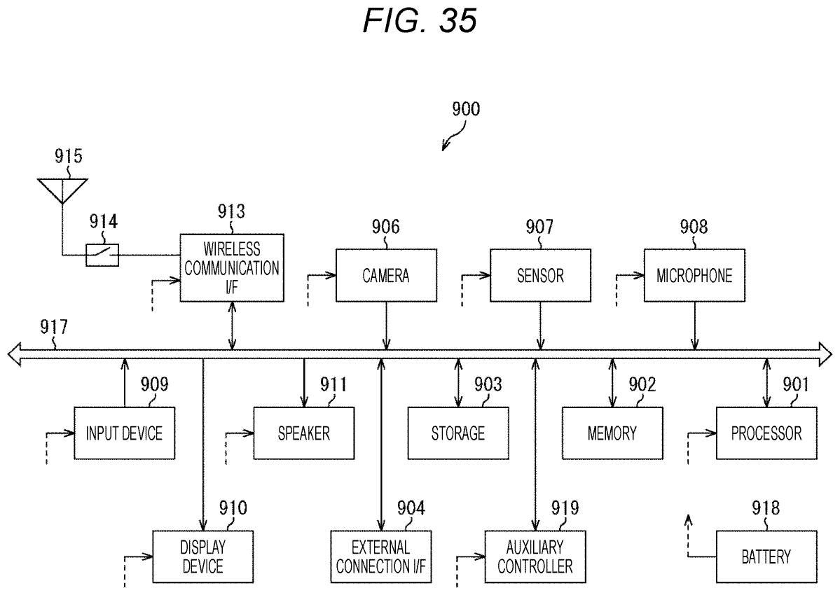

FIG. 35 is a block diagram illustrating an exemplary schematic configuration of the smartphone to which the present technology is applied.

A smartphone 900 includes a processor 901, a memory 902, storage 903, an external connection interface 904, a camera 906, a sensor 907, a microphone 908, an input device 909, and a display device 910. Furthermore, the smartphone 900 includes a speaker 911, a wireless communication interface 913, an antenna switch 914, an antenna 915, a bus 917, a battery 918, and an auxiliary controller 919.

The processor 901 may be, for example, a CPU or a system on chip (SoC), and restricts functions of an application layer and other layers of the smartphone 900.

The memory 902 includes a RAM and a ROM, and stores data and programs to be executed by the processor 901.

The storage 903 includes a storage medium such as a semiconductor memory or a hard disk.

The external connection interface 904 is an interface for connecting an external device, such as a memory card or a universal serial bus (USB) device, to the smartphone 900.

The camera 906 includes, for example, an imaging element such as a charge coupled device (CCD) or a complementary metal oxide semiconductor (CMOS), and generates a captured image.

The sensor 907 includes, for example, a sensor group including a positioning sensor, a gyro sensor, a geomagnetic sensor, an acceleration sensor, and the like.

The microphone 908 converts voice input to the smartphone 900 into an audio signal.

The input device 909 includes, for example, a touch sensor that detects a touch on a screen of the display device 910, a keypad, a keyboard, a button, a switch or the like, and receives an operation or an information input made by a user.

The display device 910 includes a screen such as a liquid crystal display (LCD) or an organic light emitting diode (OLED) display, and converts the audio signal output from the smartphone 900 into voice.

The wireless communication interface 913 supports one or more of wireless LAN standards such as IEEE 802.11a, 11b, 11g, 11ac, and 11ad, and performs wireless communication.

The wireless communication interface 913 communicates with other devices via the wireless LAN AP in an infrastructure mode. Furthermore, the wireless communication interface 913 directly communicates with other devices in an ad hoc mode or a direct communication mode such as Wi-Fi Direct.

Note that, in Wi-Fi Direct, while one of two terminals operates as an AP, communication is directly performed between those terminals, unlike the ad hoc mode.

The wireless communication interface 913 typically includes a baseband processor, a radio frequency (RF) circuit, a power amplifier, and the like. The wireless communication interface 913 may be a one-chip module in which a memory that stores a communication control program, a processor that executes the program, and related circuits are integrated.

In addition to the wireless LAN scheme, the wireless communication interface 913 may support another type of wireless communication scheme such as a short-range wireless communication scheme, a proximity wireless communication scheme, or a cellular communication scheme.

The antenna switch 914 switches a connection destination of the antenna 915 among a plurality of circuits (e.g., circuits for different wireless communication schemes) included in the wireless communication interface 913.

The antenna 915 includes a single or a plurality of antenna elements (e.g., multiple antenna elements forming a multiple input multiple output (MIMO) antenna), and is used for transmission and reception of a wireless signal by the wireless communication interface 913.

Note that, the smartphone 900 is not limited to the example of FIG. 35, and may include a plurality of antennas (e.g., antenna for a wireless LAN, antenna of the proximity wireless communication system, etc.). In that case, the antenna switch 914 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the wireless communication interface 913, and the auxiliary controller 919 to one another.

The battery 918 supplies power to each block of the smartphone 900 illustrated in FIG. 35 through a feed line partially illustrated by a broken line in the drawing. The auxiliary controller 919 causes minimum necessary functions of the smartphone 900 to operate in a sleep mode, for example.

In the smartphone 900 illustrated in FIG. 35, for example, the wireless communication module 15 in FIG. 3 may be implemented in the wireless communication interface 913. Furthermore, at least some of those functions may be implemented in the processor 901 or the auxiliary controller 919.

Note that the smartphone 900 may operate as a wireless AP (software AP) by the processor 901 executing an AP function at an application level. Furthermore, the wireless communication interface 913 may have the wireless AP function.

Moreover, the smartphone 900 may include a biometric authentication unit (fingerprint authentication, palm-shape authentication, voice authentication, blood vessel authentication, face authentication, iris authentication, or retina authentication). At that time, the wireless communication interface 913 in which the wireless communication module 15 in FIG. 3 is implemented is configured to receive power supply from the same battery 918 as at least one of the display device 910, the speaker 911, or the biometric authentication unit.

Furthermore, in the smartphone 900, information is displayed from at least one of the display device 910 or the speaker 911 on the basis of communication with an external device through the wireless communication interface 913. At that time, the information regarding the present technology may be output from at least one of the display device 910 or the speaker 911.

### Exemplary Configuration of Vehicle-Mounted Device

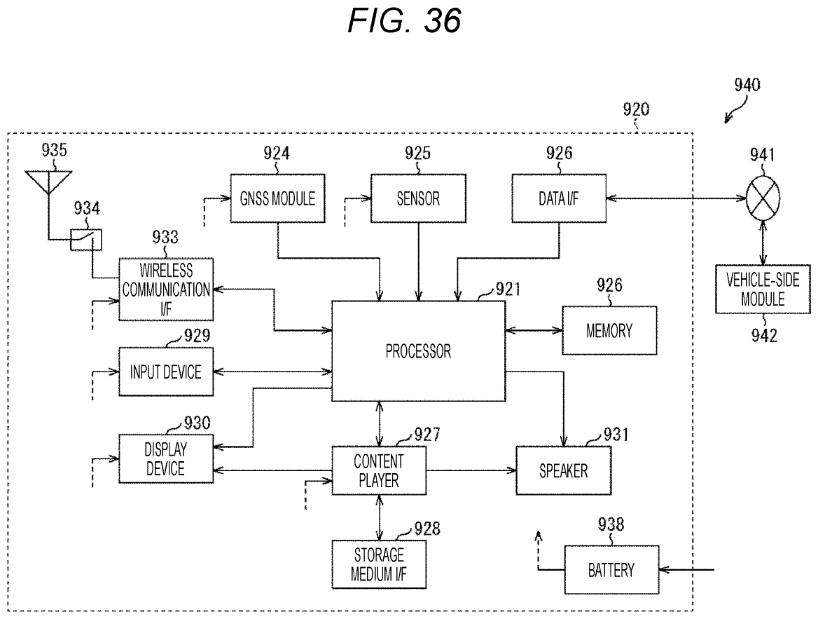

FIG. 36 is a block diagram illustrating an exemplary schematic configuration of a vehicle-mounted device 920 to which the present technology is applied.

The vehicle-mounted device 920 includes a processor 921, a memory 922, a global navigation satellite system (GNSS) module 924, a sensor 925, a data interface 926, a content player 927, and a storage medium interface 928. Furthermore, the vehicle-mounted device 920 includes an input device 929, a display device 930, a speaker 931, a wireless communication interface 933, an antenna switch 934, an antenna 935, and a battery 938.

The processor 921 may be, for example, a CPU or an SoC, and controls a navigation function and other functions of the vehicle-mounted device 920. Furthermore, the processor 921 may also control a drive system of a vehicle, such as a brake, an accelerator, or a steering, on the basis of information obtained through communication based on the present technology.

The memory 922 includes a RAM and a ROM, and stores data and programs to be executed by the processor 921.

The GNSS module 924 uses a GNSS signal received from a GNSS satellite to measure a location (e.g., latitude, longitude, and altitude) of the vehicle-mounted device 920.

The sensor 925 includes, for example, a sensor group including a gyro sensor, a geomagnetic sensor, an air pressure sensor, and the like.

The data interface 926 is connected to an in-vehicle network 941 via, for example, a terminal (not illustrated), and obtains data generated on the vehicle side, such as in-vehicle data.

The content player 927 reproduces content stored in a storage medium (e.g., CD or DVD) inserted into the storage medium interface 928.

The input device 929 includes, for example, a touch sensor that detects a touch on a screen of the display device 930, a button, a switch, or the like, and receives an operation or an information input made by the user.

The display device 930 includes a screen such as an LCD or an OLED display, and displays an image of a navigation function or reproduced content.

The speaker 931 outputs voice of the navigation function or the reproduced content.

Note that, in the vehicle-mounted device 920, the navigation function and the function of the content player 927 are optional. The navigation function and the content player 927 may be removed from the configuration of the vehicle-mounted device 920.

The wireless communication interface 933 supports one or more of wireless LAN standards such as IEEE 802.11a, 11b, 11g, 11n, 11ac, 11ad, 11ax, and 11be, and performs wireless communication. The wireless communication interface 933 communicates with other devices via the wireless LAN AP in the infrastructure mode. Furthermore, the wireless communication interface 933 directly communicates with other devices in the ad hoc mode or the direct communication mode such as Wi-Fi Direct.

The wireless communication interface 933 typically includes a baseband processor, a radio frequency (RF) circuit, a power amplifier, and the like. The wireless communication interface 933 may be a one-chip module in which a memory that stores a communication control program, and a processor that executes the program or related circuits are integrated. In addition to the wireless LAN scheme, the wireless communication interface 933 may support another type of wireless communication scheme such as the short-range wireless communication scheme, the proximity wireless communication scheme, or the cellular communication scheme.

The antenna switch 934 switches the connection destination of the antenna 935 among a plurality of circuits included in the wireless communication interface 933.

The antenna 935 includes a single or a plurality of antenna elements, and is used for transmission and reception of a wireless signal by the wireless communication interface 933.

Note that the vehicle-mounted device 920 is not limited to the example of FIG. 36, and may include a plurality of the antennas 935. In that case, the antenna switch 934 may be omitted from the configuration of the vehicle-mounted device 920.

The battery 938 may be implemented in the vehicle-mounted device 920 illustrated in FIG. 36 via a feed line partially illustrated by a broken line in the drawing, and for example, the wireless communication module 15 in FIG. 3 may be implemented in the wireless communication interface 933. Furthermore, at least some of those functions may be implemented in the processor 921.

Furthermore, the wireless communication interface 933 may operate as the wireless communication device 10 in FIG. 3, and may provide wireless connection to a terminal possessed by the user in the vehicle.

Furthermore, the present technology may be implemented as an in-vehicle system (or vehicle) 940 including one or more blocks of the vehicle-mounted device 920 described above, the in-vehicle network 941, and a vehicle-side module 942. The vehicle-side module 942 generates vehicle-side data such as a vehicle speed, an engine speed, or failure information, and outputs the generated data to the in-vehicle network 941.

### Exemplary Configuration of Wireless AP

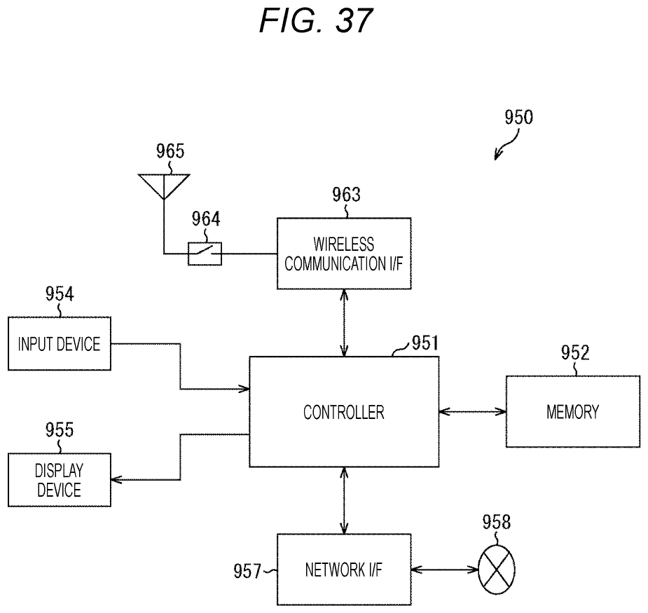

FIG. 37 is a block diagram illustrating an exemplary schematic configuration of a wireless AP 950 to which the present technology is applied.

The wireless AP 950 includes a controller 951, a memory 952, an input device 954, a display device 955, a network interface 957, a wireless communication interface 963, an antenna switch 964, and an antenna 965.

The controller 951 may be, for example, a CPU or a digital signal processor (DSP), and causes various functions (e.g., access restriction, routing, encryption, firewall, log management, etc.) of the Internet protocol (IP) layer and a higher layer of the wireless AP 950 to operate.

The memory 952 includes a RAM and a ROM, and stores programs to be executed by the controller 951 and various types of control information (e.g., terminal list, routing table, encryption key, security setting, log, etc.).

For example, the input device 954 includes a button, a switch, and the like, and receives an operation made by the user.

The display device 955 includes an LED lamp and the like, and displays an operation status of the wireless AP 950.

The network interface 957 is a wired communication interface for connecting the wireless AP 950 to a wired communication network 958. The network interface 957 may include a plurality of connecting terminals. The wired communication network 958 may be a LAN such as Ethernet (registered trademark), or may be a wide area network (WAN).

The wireless communication interface 963 supports one or more of wireless LAN standards such as IEEE 802.11a, 11b, 11g, 11n, 11ac, and 11ad, and provides wireless connection as an AP to a nearby terminal.

The wireless communication interface 963 typically includes a baseband processor, an RF circuit, a power amplifier, and the like.

The wireless communication interface 963 may be a one-chip module in which a memory that stores a communication control program, and a processor that executes the program or related circuits are integrated.

The antenna switch 964 switches a connection destination of the antenna 965 among a plurality of circuits included in the wireless communication interface 963, and the antenna 965 includes a single or a plurality of antenna elements and is used for transmission and reception of a wireless signal by the wireless communication interface 963.

In the wireless AP 950 illustrated in FIG. 37, for example, the wireless communication module 15 in FIG. 3 may be implemented in the wireless communication interface 963. Furthermore, at least some of those functions may be implemented in the controller 951.

Note that, the above-described embodiments describe an example for embodying the present technology, and there is a correspondence relationship between the matters in the embodiments and the matters specifying the invention in claims. Likewise, there is a correspondence relationship between the matters specifying the invention in claims and the matters in the embodiments of the present technology having the same names. However, the present technology is not limited to the embodiments, and may be embodied by applying various modifications to the embodiments without departing from the scope of the present technology.

Furthermore, the procedures described in the embodiments above may be considered as a method including the series of procedures, and may be considered as a program for causing this computer to execute the series of procedures or a recording medium that stores the program.

As the recording medium, for example, a compact disc (CD), a MiniDisc (MD), a digital versatile disc (DVD), a memory card, a Blu-ray (registered trademark) Disc, or the like may be used.

Note that, in the present specification, a system means an assembly of a plurality of components (devices, modules (parts), etc. ), and it does not matter whether or not all the components are housed in the same housing. Therefore, a plurality of devices housed in separate housings and connected to each other via a network and a single device including a plurality of modules housed in a single housing are both systems.

Furthermore, the effects described in the present specification are merely examples and not restrictive, and there may also be other effects.

An embodiment of the present technology is not limited to the embodiments described above, and various modifications may be made without departing from the scope of the present technology.

For example, the present technology may be configured as cloud computing in which one function is shared by a plurality of devices via a network and processed in cooperation.

Furthermore, each step described in the flowchart described above may be performed by one device, or may be performed by a plurality of devices in a shared manner.

Moreover, in a case where a plurality of types of processing is included in one step, the plurality of types of processing included in the one step may be performed by one device, or may be performed by a plurality of devices in a shared manner.

Furthermore, the present disclosure may have the following configurations.

(1)

A wireless communication device including:
a control unit that performs control including:
generating first data and second data by dividing transmission data;
transmitting a data frame including the first data or the second data; and
receiving an acknowledgement response frame including receipt information indicating a receipt status of the first data or the second data, the acknowledgement response frame being transmitted from another wireless communication device that has received the data frame.

(2)

The wireless communication device according to (1) described above, in which
the receipt information includes first specification information that specifies the first data, or second specification information that specifies the second data.

(3)

The wireless communication device according to (2) described above, in which
the control unit performs control including:
constructing an acknowledgement response request frame including the first specification information or the second specification information, and transmitting the acknowledgement response request frame to the another wireless communication device; and
receiving the acknowledgement response frame transmitted from the another wireless communication device that has received the acknowledgement response request frame.

(4)

The wireless communication device according to (3) described above, in which
the control unit includes, in the acknowledgement response request frame, information indicating a sequence range of the first data or the second data.

(5)

The wireless communication device according to (1) described above, in which
the control unit performs control of constructing and transmitting a data frame including, in a delimiter, information that requests the receipt information.

(6)

The wireless communication device according to (1) described above, in which
in a case where the receipt information included in the acknowledgement response frame indicates that the first data or the second data exists as undelivered data that has not been received by the another wireless communication device, the control unit performs control of retransmitting the undelivered data.

(7)

The wireless communication device according to any one of (1) to (6) described above, in which
the control unit performs control of constructing and transmitting a data frame in which the transmission data and the first data or the second data are aggregated.

(8)

The wireless communication device according to any one of (1) to (6) described above, in which
the control unit performs control including:
constructing a request frame that requests information indicating whether or not to receive the acknowledgement response frame, and transmitting the request frame to the another wireless communication device; and
receiving a response frame including the information indicating whether or not to receive the acknowledgement response frame, the response frame being transmitted from the another wireless communication device that has received the request frame.

(9)

The wireless communication device according to (6) described above, in which
the control unit performs control including:
constructing a request frame that requests information regarding retransmission of the first data or the second data, and transmitting the request frame to the another wireless communication device; and
receiving a response frame including the information regarding the retransmission of the first data or the second data, the response frame being transmitted from the another wireless communication device that has received the request frame.

(10)

The wireless communication device according to (3) described above, in which
the acknowledgement response request frame includes a block ACK request frame, and
the acknowledgement response frame includes a block ACK frame.

(11)

The wireless communication device according to any one of (1) to (10) described above, in which
the control unit divides the transmission data into any information length on the basis of a transmission opportunity of a transmission path.

(12)

A wireless communication method that causes a wireless communication device to perform:
generating first data and second data by dividing transmission data;
transmitting a data frame including the first data or the second data; and
receiving an acknowledgement response frame including receipt information indicating a receipt status of the first data or the second data, the acknowledgement response frame being transmitted from another wireless communication device that has received the data frame.

(13)

A wireless communication device including:
a control unit that performs control including:
receiving a data frame, which is transmitted from another wireless communication device and includes first data or second data generated by dividing transmission data;
restoring the transmission data from the first data and the second data obtained from the data frame to construct the restored transmission data as reception data; and
constructing an acknowledgement response frame including receipt information indicating a receipt status of the first data or the second data, and transmitting the acknowledgement response frame to the another wireless communication device.

(14)

The wireless communication device according to (13) described above, in which
the receipt information includes first specification information that specifies the first data, or second specification information that specifies the second data.

(15)

The wireless communication device according to (14) described above, in which
in a case where an acknowledgement response request frame, which is transmitted from the another wireless communication device and includes the first specification information or the second specification information, is received, the control unit performs control of constructing and transmitting the acknowledgement response frame on the basis of information included in the acknowledgement response request frame.

(16)

The wireless communication device according to (13) described above, in which
in a case where undelivered data exists in the first data or the second data, the control unit performs control of constructing and transmitting the acknowledgement response frame including the receipt information indicating the undelivered data.

(17)

The wireless communication device according to any one of (13) to (16), in which
the data frame includes a data frame in which the transmission data and the first data or the second data are aggregated, and
the control unit performs control of constructing the reception data from the transmission data extracted from the data frame and the transmission data restored from the first data or the second data extracted from the data frame.

(18)

The wireless communication device according to any one of (13) to (16) described above, in which
in a case where a request frame, which is transmitted from the another wireless communication device and requests information indicating whether or not to receive the acknowledgement response frame, is received, the control unit performs control of constructing a response frame including the information indicating whether or not to receive the acknowledgement response frame and transmitting the response frame to the another wireless communication device.

(19)

The wireless communication device according to (16) described above, in which
in a case where a request frame, which is transmitted from the another wireless communication device and requests information regarding retransmission of the first data or the second data, is received, the control unit performs control of constructing a response frame including the information regarding the retransmission of the first data or the second data and transmitting the response frame to the another wireless communication device.

(20)

The wireless communication device according to (15) described above, in which
the acknowledgement response request frame includes a block ACK request frame, and
the acknowledgement response frame includes a block ACK frame.

(21)

A wireless communication method that causes a wireless communication device to perform:
receiving a data frame, which is transmitted from another wireless communication device and includes first data or second data generated by dividing transmission data;
restoring the transmission data from the first data and the second data obtained from the data frame to construct the restored transmission data as reception data; and
constructing an acknowledgement response frame including receipt information indicating a receipt status of the first data or the second data, and transmitting the acknowledgement response frame to the another wireless communication device.

### REFERENCE SIGNS LIST

10 Wireless communication device
10Tx Transmission-side communication device
10Rx Reception-side communication device
11 Internet connection module
12 Information input module
13 Device control module
14 Information output module
15 Wireless communication module
101 Interface
102 Transmission buffer
103 Communication control unit
104 Frame construction unit
105 Fragment management unit
106 Transmission signal processing unit
107 Access control unit
108 Antenna control unit
109 Reception signal processing unit
110 Frame analysis unit
111 Reception buffer

1. A wireless communication device comprising:
a control unit that performs control including:
generating first data and second data by dividing transmission data;
transmitting a data frame including the first data or the second data; and
receiving an acknowledgement response frame including receipt information indicating a receipt status of the first data or the second data, the acknowledgement response frame being transmitted from another wireless communication device that has received the data frame.

2. The wireless communication device according to claim 1, wherein
the receipt information includes first specification information that specifies the first data, or second specification information that specifies the second data.

3. The wireless communication device according to claim 2, wherein
the control unit performs control including:
constructing an acknowledgement response request frame including the first specification information or the second specification information, and transmitting the acknowledgement response request frame to the another wireless communication device; and
receiving the acknowledgement response frame transmitted from the another wireless communication device that has received the acknowledgement response request frame.

4. The wireless communication device according to claim 3, wherein
the control unit includes, in the acknowledgement response request frame, information indicating a sequence range of the first data or the second data.

5. The wireless communication device according to claim 1, wherein
the control unit performs control of constructing and transmitting a data frame including, in a delimiter, information that requests the receipt information.

6. The wireless communication device according to claim 1, wherein
in a case where the receipt information included in the acknowledgement response frame indicates that the first data or the second data exists as undelivered data that has not been received by the another wireless communication device, the control unit performs control of retransmitting the undelivered data.

7. The wireless communication device according to claim 1, wherein
the control unit performs control of constructing and transmitting a data frame in which the transmission data and the first data or the second data are aggregated.

8. The wireless communication device according to claim 1, wherein
the control unit performs control including:
constructing a request frame that requests information indicating whether or not to receive the acknowledgement response frame, and transmitting the request frame to the another wireless communication device; and
receiving a response frame including the information indicating whether or not to receive the acknowledgement response frame, the response frame being transmitted from the another wireless communication device that has received the request frame.

9. The wireless communication device according to claim 6, wherein
the control unit performs control including:
constructing a request frame that requests information regarding retransmission of the first data or the second data, and transmitting the request frame to the another wireless communication device; and
receiving a response frame including the information regarding the retransmission of the first data or the second data, the response frame being transmitted from the another wireless communication device that has received the request frame.

10. The wireless communication device according to claim 3, wherein
the acknowledgement response request frame includes a block ACK request frame, and
the acknowledgement response frame includes a block ACK frame.

11. The wireless communication device according to claim 1, wherein
the control unit divides the transmission data into any information length on a basis of a transmission opportunity of a transmission path.

12. A wireless communication method that causes a wireless communication device to perform:
generating first data and second data by dividing transmission data;
transmitting a data frame including the first data or the second data; and
receiving an acknowledgement response frame including receipt information indicating a receipt status of the first data or the second data, the acknowledgement response frame being transmitted from another wireless communication device that has received the data frame.

13. A wireless communication device comprising:
a control unit that performs control including:
receiving a data frame, which is transmitted from another wireless communication device and includes first data or second data generated by dividing transmission data;
restoring the transmission data from the first data and the second data obtained from the data frame to construct the restored transmission data as reception data; and
constructing an acknowledgement response frame including receipt information indicating a receipt status of the first data or the second data, and transmitting the acknowledgement response frame to the another wireless communication device.

14. The wireless communication device according to claim 13, wherein
the receipt information includes first specification information that specifies the first data, or second specification information that specifies the second data.

15. The wireless communication device according to claim 14, wherein
in a case where an acknowledgement response request frame, which is transmitted from the another wireless communication device and includes the first specification information or the second specification information, is received, the control unit performs control of constructing and transmitting the acknowledgement response frame on a basis of information included in the acknowledgement response request frame.

16. The wireless communication device according to claim 13, wherein
in a case where undelivered data exists in the first data or the second data, the control unit performs control of constructing and transmitting the acknowledgement response frame including the receipt information indicating the undelivered data.

17. The wireless communication device according to claim 13, wherein
the data frame includes a data frame in which the transmission data and the first data or the second data are aggregated, and
the control unit performs control of constructing the reception data from the transmission data extracted from the data frame and the transmission data restored from the first data or the second data extracted from the data frame.

18. The wireless communication device according to claim 13, wherein
in a case where a request frame, which is transmitted from the another wireless communication device and requests information indicating whether or not to receive the acknowledgement response frame, is received, the control unit performs control of constructing a response frame including the information indicating whether or not to receive the acknowledgement response frame and transmitting the response frame to the another wireless communication device.

19. The wireless communication device according to claim 16, wherein
in a case where a request frame, which is transmitted from the another wireless communication device and requests information regarding retransmission of the first data or the second data, is received, the control unit performs control of constructing a response frame including the information regarding the retransmission of the first data or the second data and transmitting the response frame to the another wireless communication device.

20. The wireless communication device according to claim 15, wherein
the acknowledgement response request frame includes a block ACK request frame, and
the acknowledgement response frame includes a block ACK frame.

21. A wireless communication method that causes a wireless communication device to perform:
receiving a data frame, which is transmitted from another wireless communication device and includes first data or second data generated by dividing transmission data;
restoring the transmission data from the first data and the second data obtained from the data frame to construct the restored transmission data as reception data; and
constructing an acknowledgement response frame including receipt information indicating a receipt status of the first data or the second data, and transmitting the acknowledgement response frame to the another wireless communication device.
